(19) United States
(12) Patent Application Publication
(10) Pub. No.: US 2003/0167345 A1
(43) Pub. Date: Sep. 4, 2003

(54) Communications bridge between a vehicle information network and a remote system

(76) Inventors: Alexander N. Knight, Columbus, IN (US); Andrew J. Pajakowski, Columbus, IN (US); Jon E. Krutulis, Greenwood, IN (US); Daniel P. Wolf, Columbus, IN (US); Michael W. Phillips, Columbus, IN (US); Joseph T. Beitzinger, Cincinnati, OH (US); Lee G. Shipman, Columbus, IN (US); J. Patrick Eberly, Cincinnati, OH (US); W. Patrick Niehus, Columbus, IN (US)

Correspondence Address: BARNES & THORNBURG, 11 SOUTH MERIDIAN, INDIANAPOLIS, IN, 46204

(21) Appl. No.: 10/360,162

(22) Filed: Feb. 6, 2003

Related U.S. Application Data
(63) Continuation-in-part of application No. 10/082,196, filed on Feb. 25, 2002.

(51) Int. Cl. G06F 15/16; G05D 3/00

(52) U.S. Cl. 709/249; 701/1

(57) ABSTRACT

A communications bridge between a communications network carried by a motor vehicle and configured for communications according to a first protocol and a remote system configured for communications according to a second protocol, includes a first interface configured for coupling to the communications network, a second interface configured for coupling to the remote system, and a digital signal processor (DSP) configured to process multiple operations per instruction cycle The DSP receives information from the communications network via the first interface, converts this information to the second protocol and transmits the information converted to the second protocol to the remote system via the second interface. The DSP further receives information from the remote system via the second interface, converts this information to the first protocol and transmits the information converted to the first protocol to the communications network via the first interface.

### CROSS-REFERENCE TO RELATED APPLICATION

This is a continuation-in-part of co-pending U.S. application Ser. No.10/082,196, filed Feb. 25, 2002, and entitled VEHICLE COMMUNICATIONS NETWORK ADAPTER.

### FIELD OF THE INVENTION

The present invention relates generally to information communication systems, and more specifically to a communications bridge for providing information exchange between one or more vehicle information networks and one or more remote systems, wherein the communications protocols of the one or more vehicle information networks are different than those of the one or more remote systems.

### BACKGROUND OF THE INVENTION

Motor vehicles include various electronic control computers mounted in the vehicle. The control computers may control various systems and/or subsystems within the vehicle. For example, a control computer may control the fuel system, the transmission, the brakes or the steering mechanism. These control computers are typically coupled to a variety of sensors and/or actuators. In commercial vehicles, control computers are often included that log data regarding usage of the vehicle, such as maximum speed, fuel usage, maximum acceleration, hours of usage, and the like. Such systems may even incorporate a Global Positioning System (GPS) receiver to log where the vehicle has traveled.

These control computers communicate with each other, and with external service equipment, via one or more vehicle communications networks. Standards for vehicle communications network protocols have been developed and are well known in the art. For example, the Society of Automotive Engineers (SAE) has developed standards concerning the design and use of devices that transmit electronic signals and control information between vehicle components. Some of these standards are SAE J1939, SAE J1850, and SAE J1587/J1708 (SAE J1708 is a specific implementation of an RS-485 communications hardware structure, wherein communications over a J1708 structure may be conducted in accordance with a communications protocol defined by SAE J1587, as is known in the art). Other standards have been developed by other organizations, such as ISO-9141 developed by the International Standards Organization.

Service equipment has been utilized in the past to diagnose problems with control computers, download information logged by control computers, and upload information to control computers. For example, a control computer may limit the maximum speed or maximum torque of vehicle, and this maximum value may be programmable via a computer-based service tool. In some vehicles, a host of parameters, even the fuel mapping, may be modified via service equipment.

Service equipment may be generally categorized as a hand-held or stationary device used to communicate information to and/or from one or more control computers carried by a motor vehicle. A handheld service device is often referred to as a “service tool”, and may be used for, among other things, trouble-shooting faults associated with on-board control computers. A typical service tool includes a central processing unit (cpu) and a custom interface circuit to facilitate communication between the cpu and one or more of the control computers in the vehicle. Many service tools are “custom” made, designed to interface only with one or more of the control computers produced by a particular manufacturer, and often only to certain models produced by a particular manufacturer.

Stationary service equipment is generally used for retrieving data logs, and other more involved tasks, although for many purposes hand-held and stationary service equipment may be interchangeable. Recent designs for stationary service equipment have implemented personal computers (PCs). Current methods for coupling one or more vehicle control computers to a personal computer (PC) require custom, cpu-based interfaces which translate the communication protocols of the one or more vehicle control computers (i.e., SAE J1939 and/or SAE J1587/J1708) into a PC communication standard, such as RS-232 (standard serial) or peripheral computer interface (PCI). These custom interface adapters typically include a PCI interface board mounted in the PC, or an external “pod” which is coupled between the one or more vehicle control computer(s) and the PC.

Many manufacturers today market handheld computers for non-automotive applications. For example, a personal digital assistant (PDA) is a handheld, pen-based computer that combines personal information manager (PIM) functionality, such as a calendar and an address book, with computing features. Most PDAs are designed to communicate with a “host” computer, generally a personal computer (PC), via either an RS-232 serial port or a Universal Serial Bus (USB) port.

Such handheld computer systems may be used as a device for assisting in the extraction, display and upload of engine/vehicle information for transfer and analysis. One such system is described in U.S. patent application Ser. No. 09/583,892, titled “Handheld computer based system for collection, display, and analysis of engine/vehicle data”, which is assigned to the assignee of the present invention, and the disclosure of which is incorporated herein by reference.

Both PDAs and PCs typically include, or may be retrofitted with, USB ports. USB ports are much more versatile than standard serial ports for a number of reasons. For example, standard serial ports are “point-to-point”, so that only two devices may be connected together for communication via a standard serial link. By contrast, USB provides a multi-point serial link, so that multiple computers may be connected in communication via one data link. As another example, standard serial ports are much slower than USB ports. The maximum attainable speed on a standard serial port is currently in the range of 115 Kb/s. By contrast, high-speed USB is over 400 times faster, attaining transfer rates of 480 Mb/s, and full-speed USB is 100 times faster, attaining data rates of 12 Mb/s.

However, a computer attached to a multi-point USB serial link must either be configured as a “device”, or a “host”. Many devices may be attached to one host. However, on any one link, two hosts may not be directly connected to one another, nor may two devices be directly connected to one another. Some computers include an On-The-Go (OTG) USB port, which allows them to function as a device, or a limited-function host, depending on the type of cable inserted into the port. Computers with an On-The-Go USB port may always be connected to a host (that is, function as a device), and may also be connected to a device (that is, function as a host) if the device is one which the On-The-Go USB port equipped computer is configured to support. Moreover, some USB controllers include a single port that is dynamically configurable as a device, host or OTG port so that only a single port is needed to support any of the USB configurations.

There also exist “Pocket PCs” with USB host capability, and PCs, PDAs, and other computerized devices with USB On-The-Go capability. Any USB computing device (PC, PDA, Pocket PC, etc.) may have any combination of USB host, device, or On-The-Go ports. Nothing in this disclosure is intended to indicate a limit in the possible USB combinations that may be included in a given type of computer.

The USB protocol is described in the “Universal Serial Bus Specification”, revision 2.0, Apr. 27, 2000, in “Errata to the USB 2.0 Specification”, Dec. 7, 2000, and in the “On-The-Go Supplement to the USB 2.0 Specification”, Revision 1.0 Dec. 18, 2001, all three of which are hereby incorporated by reference.

It is desirable to provide a communications bridge configured to convert any of one or more engine/vehicle data link communications protocols (e.g., J1939, J1587/J1708, etc.) to any of one or more computer-based remote system or unit communications protocols (e.g., RS-232, USB, etc.) to facilitate communications between any control computer carried by a motor vehicle and a computer-based remote system or unit. However, it has been discovered through experimentation that microprocessor-based communication bridges of this type suffer from a number of drawbacks. For example, due to the multiple-instruction-cycle nature and limited processing throughput of typical microprocessor-based architectures, microprocessor-based communication bridges often experience faults or failures when attempting to convert and transmit multiple-frame data messages. When this occurs, the message being converted and sent is aborted and therefore must be resent.

What is therefore needed is a communications bridge configured to convert any of one or more engine/vehicle data link communications protocols (e.g., J1939, J1587/J1708, etc.) to any of one or more computer-based remote system or unit communications protocols (e.g., RS-232, USB, etc.), but that does not suffer from the foregoing drawbacks.

### SUMMARY OF THE INVENTION

According to one aspect of the invention, an adapter is provided for allowing communications between a vehicle control computer coupled to a vehicle communications network and a remote computer. The adapter comprises a first interface configured for operatively coupling to the vehicle communications network, a second interface including a universal serial bus (USB) controller having a USB device port and a USB host port, the second interface configured for operatively coupling to the remote computer via the USB device port and the USB host port. The vehicle control computer and the remote computer communicate via the vehicle communications network and the first and second interfaces.

Illustratively according to this aspect of the invention, the remote computer is a personal digital assistant having a USB device port, and the USB device port of the personal digital assistant is operatively coupled to the USB host port of the universal serial bus controller.

Further illustratively according to this aspect of the invention, the personal digital assistant comprises service tool software.

Illustratively according to this aspect of the invention, the remote computer is a personal computer having a USB host port, and the USB host port of the personal computer is operatively coupled to the USB device port of the universal serial bus controller.

Alternatively illustratively according to this aspect of the invention, the personal computer comprises vehicle diagnostic software.

Alternatively illustratively according to this aspect of the invention, the USB host port of the universal serial bus controller is configured for coupling with a plurality of remote computers, each of the plurality of remote computers having a USB device port.

Further illustratively according to this aspect of the invention, at least one of the plurality of remote computers comprises vehicle diagnostic software.

Alternatively illustratively according to this aspect of the invention, the vehicle communications network comprises a J1939 network segment, and the first interface of the adapter is operatively coupled to the J1939 network segment.

Further illustratively according to this aspect of the invention, messages communicated via the J1939 network segment are made available via the second interface.

Further illustratively according to this aspect of the invention, the remote computer is a personal digital assistant having a USB device port, the USB device port of the personal digital assistant is operatively coupled to the USB host port of the universal serial bus controller, and messages communicated via the J1939 network segment are further communicated to the personal digital assistant.

Alternatively illustratively according to this aspect of the invention, the remote computer is a personal computer having a USB host port, the USB host port of the personal computer is operatively coupled to the USB device port of the universal serial bus controller, and messages communicated via the J1939 network segment are further communicated to the personal computer.

Alternatively illustratively according to this aspect of the invention, the vehicle communications network comprises a J1587 network segment, and the first interface of the adapter is operatively coupled to the J1587 network segment.

Further illustratively according to this aspect of the invention, messages communicated via the J1587 network segment are made available via the second interface.

Further illustratively according to this aspect of the invention, the remote computer is a personal digital assistant having a USB device port, the USB device port of the personal digital assistant is operatively coupled to the USB host port of the universal serial bus controller, and messages communicated via the J1587 network segment are further communicated to the personal digital assistant.

Alternatively illustratively according to this aspect of the invention, the remote computer is a personal computer having a USB host port, the USB host port of the personal computer is operatively coupled to the USB device port of the universal serial bus controller, and messages communicated via the J1587 network segment are further communicated to the personal computer.

Alternatively illustratively according to this aspect of the invention, the adapter further comprising a third interface configured for operatively coupling to a second remote computer, the third interface comprises an RS-232 serial port.

Further illustratively according to this aspect of the invention, the second remote computer is a personal digital assistant having an RS-232 serial port, and the RS-232 serial port of the personal digital assistant is operatively coupled to the RS-232 serial port of the adapter.

Further illustratively according to this aspect of the invention, the personal digital assistant comprises service tool software.

Illustratively according to this aspect of the invention, the second remote computer is a personal computer having an RS-232 serial port, and the RS-232 serial port of the personal computer is operatively coupled to the RS-232 serial port of the adapter.

Further illustratively according to this aspect of the invention, the personal computer comprises vehicle diagnostic software.

Illustratively according to this aspect of the invention, the universal serial bus controller further comprises a USB On-The-Go port.

Alternatively illustratively according to this aspect of the invention, the remote computer is a personal digital assistant having a USB device port, and the USB device port of the personal digital assistant is operatively coupled to the USB On-The-Go port of the universal serial bus controller.

Alternatively illustratively according to this aspect of the invention, the remote computer is a personal computer having a USB host port, and the USB host port of the personal computer is operatively coupled to the USB On-The-Go port of the universal serial bus controller.

According to another aspect of the invention, an adapter is provided for allowing communications between a vehicle control computer coupled to a J1939 network of a vehicle and a remote computer. The adapter comprises a first interface configured for operatively coupling to the J1939 network, and a second interface including a universal serial bus (USB) controller having a USB device port and a USB host port, the second interface configured for operatively coupling to the remote computer via the USB device port and the USB host port. The vehicle control computer and the remote computer communicate via the J1939 network and the first and second interfaces.

Illustratively according to this aspect of the invention, the remote computer is a personal digital assistant having a USB device port, and the USB device port of the personal digital assistant is operatively coupled to the USB host port of the universal serial bus controller.

Further illustratively according to this aspect of the invention, the remote computer is a personal computer having a USB host port, and the USB host port of the personal computer is operatively coupled to the USB device port of the universal serial bus controller.

Alternatively illustratively according to this aspect of the invention, the USB host port of the universal serial bus controller is configured for coupling with a plurality of remote computers, each of the plurality of remote computers having a USB device port.

Alternatively illustratively according to this aspect of the invention, the adapter further comprising a third interface configured for operatively coupling to a computer, the third interface comprises an RS-232 serial port.

Further illustratively according to this aspect of the invention, the universal serial bus controller further comprises a USB On-The-Go port.

Further illustratively according to this aspect of the invention, the remote computer is a personal digital assistant having a USB device port, and the USB device port of the personal digital assistant is operatively coupled to the USB On-The-Go port of the universal serial bus controller.

Further illustratively according to this aspect of the invention, the remote computer is a personal computer having a USB host port, and the USB host port of the personal computer is operatively coupled to the USB On-The-Go port of the universal serial bus controller.

According to another aspect of the invention, an adapter is provided for allowing communications between a vehicle control computer coupled to a J1587 network of a vehicle and a remote computer. The adapter comprises a first interface configured for operatively coupling to the J1587 network, and a second interface including a universal serial bus (USB) controller having a USB device port and a USB host port, the second interface configured for operatively coupling to the remote computer via the USB device port and the USB host port. The vehicle control computer and the remote computer communicate via the J1587 network and the first and second interfaces.

Illustratively according to this aspect of the invention, the remote computer is a personal digital assistant having a USB device port, and the USB device port of the personal digital assistant is operatively coupled to the USB host port of the universal serial bus controller.

Further illustratively according to this aspect of the invention, the remote computer is a personal computer having a USB host port, and the USB host port of the personal computer is operatively coupled to the USB device port of the universal serial bus controller.

Alternatively illustratively according to this aspect of the invention, the USB host port of the universal serial bus controller is configured for coupling with a plurality of remote computers, each of the plurality of remote computers having a USB device port.

Alternatively illustratively according to this aspect of the invention, the adapter further comprising a third interface configured for operatively coupling to a second remote computer, the third interface comprises an RS-232 serial port.

Further illustratively according to this aspect of the invention, the universal serial bus controller further comprises a USB On-The-Go port.

Further illustratively according to this aspect of the invention, the remote computer is a personal digital assistant having a USB device port, and the USB device port of the personal digital assistant is operatively coupled to the USB On-The-Go port of the universal serial bus controller.

Alternatively illustratively according to this aspect of the invention, the remote computer is a personal computer having a USB host port, and the USB host port of the personal computer is operatively coupled to the USB On-The-Go port of the universal serial bus controller.

According to another aspect of the invention, an adapter is provided for allowing communications between control computers of a vehicle and a remote computer. The adapter comprises a first interface configured for operatively coupling to a J1939 network segment of the vehicle, a second interface configured for operatively coupling to a J1587 network segment of the vehicle, and a third interface including a universal serial bus (USB) controller having a USB device port and a USB host port. The third interface is configured for operatively coupling to the remote computer via the USB device port and the USB host port. Each control computer of the vehicle and the remote computer communicate via one of the J1939 network and the first and third interfaces, and the J1587 network and the second and third interfaces.

Illustratively according to this aspect of the invention, the remote computer is a personal digital assistant having a USB device port, and the USB device port of the personal digital assistant is operatively coupled to the USB host port of the universal serial bus controller.

Alternatively illustratively according to this aspect of the invention, the remote computer is a personal computer having a USB host port, and the USB host port of the personal computer is operatively coupled to the USB device port of the universal serial bus controller.

Alternatively illustratively according to this aspect of the invention, the USB host port of the universal serial bus controller is configured for coupling with a plurality of remote computers, each of the plurality of remote computers having a USB device port.

Alternatively illustratively according to this aspect of the invention, the universal serial bus controller further comprises a USB On-The-Go port.

Further illustratively according to this aspect of the invention, the remote computer is a personal digital assistant having a USB device port, and the USB device port of the personal digital assistant is operatively coupled to the USB On-The-Go port of the universal serial bus controller.

Further illustratively according to this aspect of the invention, the remote computer is a personal computer having a USB host port, and the USB host port of the personal computer is operatively coupled to the USB On-The-Go port of the universal serial bus controller.

According to another aspect of the invention, an adapter is provided for allowing communications between a vehicle control computer operatively coupled to a communication network of a vehicle and a remote computer. The method comprises receiving a datum via a first interface, the first interface operatively coupled to the communication network of the vehicle, transmitting the datum via a second interface, the second interface including a universal serial bus controller having a USB device port and a USB host port, the second interface is configured for operatively coupling to a computer via the USB device port and the USB host port. The first datum is transmitted by the vehicle control computer, and the first datum is received by the remote computer.

Illustratively according to this aspect of the invention, the datum is a network message, the network message comprising a destination address.

Further illustratively according to this aspect of the invention, the transmitting step comprises determining whether the network message is bound for the second interface, and transmitting the network message via a second interface only if the network message is bound for the second interface.

Further illustratively according to this aspect of the invention, determining whether the network message is bound for the second interface comprises reading the address and comparing it to an existing address.

Alternatively illustratively according to this aspect of the invention, the transmitting step comprises transmitting the network message via a second interface irrespective of the destination address of the network message.

According to another aspect of the invention, an adapter is provided for allowing communications between a vehicle control computer operatively coupled to a vehicle communications network and a remote computer. The adapter comprises a first interface configured for operatively coupling to the vehicle communications network, and a second interface including a USB On-The-Go port. The second interface is configured for operatively coupling to the remote computer via the USB On-The-Go port. The vehicle control computer and the remote computer communicate via the vehicle communications network and the first and second interfaces.

Illustratively according to this aspect of the invention, the remote computer is a personal digital assistant having a USB device port, and the USB device port of the personal digital assistant is operatively coupled to the USB On-The-Go port of the universal serial bus controller.

Further illustratively according to this aspect of the invention, the personal digital assistant comprises service tool software.

Alternatively illustratively according to this aspect of the invention, the remote computer is a personal computer having a USB host port, and the USB host port of the personal computer is operatively coupled to the USB On-The-Go port of the universal serial bus controller.

Alternatively illustratively according to this aspect of the invention, the personal computer comprises vehicle diagnostic software.

Alternatively illustratively according to this aspect of the invention, the vehicle communications network comprises a J1939 network segment, and the first interface of the adapter is operatively coupled to the J1939 network segment.

Further illustratively according to this aspect of the invention, messages communicated via the J1939 network segment are made available via the second interface.

Further illustratively according to this aspect of the invention, the remote computer is a personal digital assistant having a USB device port, the USB device port of the personal digital assistant is operatively coupled to the USB On-The-Go port of the universal serial bus controller, and messages communicated via the J1939 network segment are further communicated to the personal digital assistant.

Alternatively illustratively according to this aspect of the invention, the remote computer is a personal computer having a USB host port, the USB host port of the personal computer is operatively coupled to the USB On-The-Go port of the universal serial bus controller, and messages communicated via the J1939 network segment are further communicated to the personal computer.

Alternatively illustratively according to this aspect of the invention, the vehicle communications network comprises a J1587 network segment, and the first interface of the adapter is operatively coupled to the J1587 network segment.

Further illustratively according to this aspect of the invention, messages communicated via the J1587 network segment are made available via the second interface.

Further illustratively according to this aspect of the invention, the remote computer is a personal digital assistant having a USB device port, the USB device port of the personal digital assistant is operatively coupled to the USB On-The-Go port of the universal serial bus controller, and messages communicated via the J1587 network segment are further communicated to the personal digital assistant.

Alternatively illustratively according to this aspect of the invention, the remote computer is a personal computer having a USB host port, the USB host port of the personal computer is operatively coupled to the USB On-The-Go port of the universal serial bus controller, and messages communicated via the J1587 network segment are further communicated to the personal computer.

Alternatively illustratively according to this aspect of the invention, the adapter further comprising a third interface configured for operatively coupling to a second remote computer, the third interface comprises an RS-232 serial port.

Further illustratively according to this aspect of the invention, the second remote computer is a personal digital assistant having an RS-232 serial port, and the RS-232 serial port of the personal digital assistant is operatively coupled to the RS-232 serial port of the adapter.

Further illustratively according to this aspect of the invention, the personal digital assistant comprises service tool software.

Further illustratively according to this aspect of the invention, the second remote computer is a personal computer having an RS-232 serial port, and the RS-232 serial port of the personal computer is operatively coupled to the RS-232 serial port of the adapter.

Further illustratively according to this aspect of the invention, the personal computer comprises vehicle diagnostic software.

According to another aspect of the invention, an adapter is provided for allowing communications between control computers of a vehicle and a remote computer. The adapter comprises a first interface configured for operatively coupling to a J1939 network segment of the vehicle, a second interface configured for operatively coupling to a J1587 network segment of the vehicle, and a third interface including a USB On-The-Go port, the third interface configured for operatively coupling to the remote computer via the USB On-The-Go port. Each control computer of the vehicle and the remote computer communicate via one of the J1939 network and the first and third interfaces, and the J1587 network and the second and third interfaces.

Further illustratively according to this aspect of the invention, the remote computer is a personal digital assistant or personal computer having a USB On-The-Go port, and wherein the USB On-The-Go port of the remote computer is operatively coupled to the USB On-The-Go port of the adapter.

Further illustratively according to this aspect of the invention, the remote computer is a personal digital assistant having a USB device port, and wherein the USB device port of the personal digital assistant is operatively coupled to the USB On-The-Go port of the adapter.

Alternatively illustratively according to this aspect of the invention, the remote computer is a personal computer having a USB host port, and wherein the USB host port of the personal computer is operatively coupled to the USB On-The-Go port of the adapter.

Further illustratively according to this aspect of the invention, the remote computer comprises service tool software.

Further illustratively according to this aspect of the invention, wherein the remote computer comprises vehicle diagnostic software.

Alternatively illustratively according to this aspect of the invention, the adapter further comprises a fourth interface configured for operatively coupling to a second remote computer, wherein the fourth interface comprises an RS-232 serial port.

Further illustratively according to this aspect of the invention, the second remote computer is a personal digital assistant having an RS-232 serial port, and wherein the RS-232 serial port of the personal digital assistant is operatively coupled to the RS-232 serial port of the adapter.

Alternatively illustratively according to this aspect of the invention, wherein the second remote computer is a personal computer having an RS-232 serial port, and wherein the RS-232 serial port of the personal computer is operatively coupled to the RS-232 serial port of the adapter.

Alternatively illustratively according to this aspect of the invention, wherein the second remote computer comprises service tool software.

Alternatively illustratively according to this aspect of the invention, wherein the second remote computer comprises vehicle diagnostic software.

Alternatively illustratively according to this aspect of the invention, the remote computer is the second remote computer.

The present invention may further comprise one or more of the following features or combinations thereof. A communications bridge between a communications network carried by a motor vehicle and configured for communications according to a first protocol and a remote system configured for communications according to a second protocol may comprise a first interface configured for coupling to the communications network, a second interface configured for coupling to the remote system, and a digital signal processor (DSP) configured to process multiple operations per instruction cycle. The DSP may receive information configured according to the first protocol from the communications network via the first interface, convert the information received from the communications network and configured according to the first protocol to the second protocol, and transmit the information converted to the second protocol to the remote system via the second interface. The DSP may further receive information configured according to the second protocol from the remote system via the second interface, convert the information received from the remote system and configured according to the second protocol to the first protocol, and transmit the information converted to the first protocol to the communications network via the first interface.

The communications may further include a control computer carried by the motor vehicle and connected in communication with the communications network, wherein the control computer provides the information configured according to the first protocol to the communications network.

The communications network carried by the motor vehicle may be a Society of Automotive Engineers (SAE) J1708 hardware network, wherein the first protocol is an SAE J1587 communications protocol configured for communication over the SAE J1708 hardware network. The first interface may be a first transceiver configured for coupling to the SAE J1708 hardware network, wherein the first transceiver is operable to transmit and receive the information configured according to the SAE J1587 communications protocol to and from the SAE J1708 hardware network. The communications network may further include a control computer carried by the motor vehicle and connected in communication with the SAE J1708 hardware network, wherein the control computer provides the information configured according to the SAE J1587 protocol to the SAE J1708 hardware network. In this embodiment, the second protocol may be an RS-232 communications protocol, and the second interface may be a second transceiver configured for coupling to an RS-232 communications port of the remote system, wherein the second transceiver is operable to transmit and receive the information configured according to the RS-232 communications protocol to and from the remote system. Alternatively, the second protocol may be a universal serial bus (USB) communications protocol, and the second interface may be a USB controller having a first USB interface port configured for coupling to a second USB interface port of the remote system, wherein the USB controller is operable to transmit and receive the information configured according to the USB communications protocol to and from the remote system. The remote system may be configured as a USB device, wherein the first USB interface port is configured as a USB host port or an on-the-go USB port operable as a host USB port. The remote system may alternatively be configured as a USB host, wherein the first USB interface port is configured as a USB device port or as an on-the-go USB port operable as a device USB port. In any case, the remote system may be a personal computer, a hand-held personal digital assistant device or other remote system or unit.

The communications network carried by the motor vehicle may alternatively be a Society of Automotive Engineers (SAE) J1939 hardware network, wherein the first protocol is an SAE J1939 communications protocol configured for communication over the SAE J1939 hardware network. The first interface may be a first transceiver configured for coupling to the SAE J1939 hardware network, wherein the first transceiver is operable to transmit and receive the information configured according to the SAE J1939 communications protocol to and from the SAE J1939 hardware network. The communications network may further include a control computer carried by the motor vehicle and connected in communication with the SAE J1939 hardware network, wherein the control computer provides the information configured according to the SAE J1939 protocol to the SAE J1939 hardware network. In this embodiment, the second protocol may be an RS-232 communications protocol, and the second interface may be a second transceiver configured for coupling to an RS-232 communications port of the remote system, wherein the second transceiver is operable to transmit and receive the information configured according to the RS-232 communications protocol to and from the remote system. The second protocol may alternatively be a universal serial bus (USB) communications protocol, and the second interface may be a USB controller having a first USB interface port configured for coupling to a second USB interface port of the remote system, wherein the USB controller is operable to transmit and receive the information configured according to the USB communications protocol to and from the remote system. The remote system may be configured as a USB device, wherein the first USB interface port is configured as a USB host port or as an on-the-go USB port operable as a host USB port. Alternatively, the remote system may be configured as a USB host, wherein the first USB interface port is configured as a USB device port or as an on-the-go USB port operable as a device USB port. In either case, the remote system may be a personal computer, a hand-held personal digital assistant device or other remote system or unit.

The communications bridge may further include a power supply configured to provide a first supply voltage to the first transceiver.

The communications bridge may further include a power source selection circuit receiving one or more source voltages and selectively supplying one of the one or more source voltages as an input voltage to the power supply, wherein the power supply produces the first supply voltage as a function of the input voltage. The power supply may further be configured to provide a second supply voltage, as a function of the input voltage, to the DSP and to the second transceiver, wherein the second supply voltage is less than the first supply voltage. The DSP may further include programmable flash memory, wherein the power supply may be further configured to provide a flash memory programming voltage, as a function of the input voltage, to the DSP.

The one or more source voltages may include a DC voltage supplied to the communications bridge via an external voltage source.

The communications bridge may further include at least one battery supplying a battery voltage, wherein the one or more source voltages may include the battery voltage supplied by the battery.

The communications bridge may further include an external battery charging circuit receiving a charging voltage produced by the power supply and providing the charging voltage externally to the communications bridge. The remote system may be a personal digital assistant (PDA) device, wherein the charging voltage produced by the external battery charging circuit may be supplied to the PDA to charge one or more batteries carried thereby. The DSP may include a voltage measuring input monitoring the charging voltage produced by the power supply, wherein the DSP measures the charging voltage and provides a resulting measured voltage value to the PDA via a diagnostic message transmitted by the second transceiver.

The DSP may include a voltage measuring input monitoring the external source voltage supplied to the power source selection circuit.

The communications bridge may further including a power supply status indicator, and a driver circuit having a control input connected to a control output of the DSP and a driver output connected to the power supply status indicator, wherein the DSP is operable to control the power supply status indicator via the driver circuit to provide a visual indication of the measured value of the external source voltage. The power supply status indicator may be a power supply status light emitting diode (LED), wherein the DSP controls the power supply status LED via the driver circuit such that the power supply status LED is illuminated whenever the measured value of the external source voltage is within a predefined voltage range, and is switched to an off state whenever the measured value of the external source voltage is below a threshold voltage value less than the predefined voltage range. The DSP may be further operable to control the power supply status LED via the driver circuit such that the power supply status LED switches on and off at a predefined switching rate whenever the measured value of the external source voltage is outside the predefined voltage range.

The communications bridge may further include another status indicator, and a driver circuit having a control input connected to a control output of the DSP and a driver output connected to the status indicator, wherein the DSP is operable to control the status indicator via the driver circuit to provide a visual indication of the status of information transfer between the communications network and the remote system.

The communications network carried by the motor vehicle may be a Society of Automotive Engineers (SAE) J1708 hardware network and the first protocol is an SAE J1587 communications protocol configured for communication over the SAE J1708 hardware network, wherein the first transceiver is operable to transmit and receive the information configured according to the SAE J1587 communications protocol to and from the SAE J1708 hardware network. The status indicator in this case may be a J1587/J1708 communications status light emitting diode (LED), wherein the DSP switches the J1587/J1708 communications status LED on and off at a first predefined switching rate if the J1708 hardware network is non-responsive and the DSP is transmitting data via the first transceiver, the DSP switches the J1587/J1708 communications status LED on and off at a second predefined switching rate faster than the first switching rate if the J1708 hardware network is responsive and the DSP is transmitting information to and receiving information from the communications network via the first transceiver, and the DSP maintains the J1587/J1708 communications status LED in an off state whenever the DSP is neither transmitting information to nor receiving information from the J1708 hardware network via the first transceiver.

The communications network carried by the motor vehicle may alternatively be, or include, a Society of Automotive Engineers (SAE) J1939 hardware network and the first protocol is an SAE J1939 communications protocol configured for communication over the SAE J1939 hardware network, and wherein the first transceiver is a controller area network (CAN) transceiver operable to transmit and receive the information configured according to the SAE J1939 communications protocol to and from the SAE J1939 hardware network. The status indicator in this case may be a J1939 communications status light emitting diode (LED), wherein the DSP switches the J1939 communications status LED on and off at a first predefined switching rate if the J1939 hardware network is non-responsive and the DSP is transmitting data via the first transceiver, the DSP switches the J1939 communications status LED on and off at a second predefined switching rate faster than the first switching rate if the J1939 hardware network is responsive and the DSP is transmitting information to and receiving information from the communications network via the CAN transceiver, and the DSP maintains the J1939 communications status LED in an off state whenever the DSP is neither transmitting information to nor receiving information from the J1939 hardware network via the CAN transceiver.

The second protocol may be an RS-232 communications protocol, wherein the second transceiver is configured for coupling to an RS-232 communications port of the remote system, and the second transceiver operable to transmit and receive the information configured according to the RS-232 communications protocol to and from the remote system. In this case, the status indicator may be an RS-232 communications status light emitting diode (LED), wherein the DSP switches the RS-232 communications status LED on and off at a first predefined switching rate if the RS-232 communications port of the remote system is non-responsive and the DSP is transmitting data via the second transceiver, the DSP switches the RS-232 communications status LED on and off at a second predefined switching rate faster than the first switching rate if the RS-232 communications port of the remote system is responsive and the DSP is transmitting information to and receiving information from the remote system via the second transceiver, and the DSP maintains the RS-232 communications status LED in an off state whenever the DSP is neither transmitting information to nor receiving information from the remote system via the second transceiver.

The second protocol may be a universal serial bus (USB) communications protocol, wherein the second transceiver is a USB controller and transceiver circuit having a first USB port configured for coupling to a second USB port of the remote system, and the USB controller and transceiver circuit is operable to transmit and receive the information configured according to the USB communications protocol to and from the remote system. In this case, the status indicator may be a USB communications status light emitting diode (LED), wherein the DSP switches the USB communications status LED on and off at a first predefined switching rate if the second USB port of the remote system is non-responsive and the DSP is transmitting data via the USB controller and transceiver circuit, the DSP switches the USB communications status LED on and off at a second predefined switching rate faster than the first switching rate if the second USB port of the remote system is responsive and the DSP is transmitting information to and receiving information from the remote system via the USB controller and transceiver circuit, and the DSP maintains the USB communications status LED in an off state whenever the DSP is neither transmitting information to nor receiving information from the remote system via the USB controller and transceiver circuit.

A method of communicating information between at least one communications network carried by a motor vehicle and a remote system, the at least one communication network configured for communications according to a first protocol and the remote system configured for communications according to a third protocol, may comprise the steps of receiving via a first interface coupled to the at least one communications network a first set of data from the at least one communications network configured according to the first protocol, providing the first set of data received via the first interface to a digital signal processor (DSP) configured to process multiple operations per instruction cycle, converting with the DSP the first set of data from the first protocol to the second protocol, providing the first set of data configured according to the second protocol from the DSP to a second interface coupled to the remote system, and transmitting to the remote system via the second interface the first data set configured according to the second protocol.

The method may further include the steps of receiving from the remote system via the second interface a second set of data configured according to the second protocol, providing the second set of data received via the second interface to the digital signal processor (DSP), converting with the DSP the second set of data from the second protocol to the first protocol in accordance with a number of single-clock cycle DSP instructions, providing the second set of data configured according to the first protocol from the DSP to the first interface, and transmitting to the at least one communications network via the first interface the second data set configured according to the first protocol.

The vehicle carrying the at least one communications network may include another communications network configured for communications according to a third protocol, and the method may further include the steps of receiving via a third interface coupled to the another communications network a third set of data from the another communications network configured according to the third protocol, providing the third set of data received via the third interface to the digital signal processor (DSP), converting with the DSP the third set of data from the third protocol to the second protocol in accordance with a number of single-clock cycle DSP instructions, providing the third set of data configured according to the second protocol from the DSP to the second interface, and transmitting to the remote system via the second interface the third data set configured according to the second protocol.

The method may further include the steps of receiving from the remote system via the second interface a fourth set of data configured according to the second protocol, providing the fourth set of data received via the second interface to the digital signal processor (DSP), converting with the DSP the fourth set of data from the second protocol to the third protocol in accordance with a number of single-clock cycle DSP instructions, providing the fourth set of data configured according to the third protocol from the DSP to the third interface, and transmitting to the another communications network via the third interface the fourth data set configured according to the third protocol.

The at least one communications network may be a society of automotive engineers (SAE) J1708 hardware network and the first protocol is an SAE J1587 communications protocol configured for communication over the J1708 hardware network, and the other communications network may be an SAE J1939 hardware network and the third protocol is an SAE J1939 communications protocol configured for communication over the J1939 hardware network.

The second protocol may be an RS-232 communications protocol.

The second protocol may alternatively be a universal serial bus (USB) communications protocol.

These and other objects of the present invention will become more apparent from the following description of the illustrative embodiments.

### BRIEF DESCRIPTION OF THE DRAWINGS

FIG. 1A is a block diagram illustrating one preferred embodiment of a vehicle communications network, in accordance with the present invention.

FIG. 1B is a block diagram illustrating an alternate embodiment of a vehicle communications network, in accordance with the present invention.

FIG. 2 is a block diagram illustrating one preferred embodiment of a vehicle communications network adapter, in accordance with the present invention.

FIG. 3 is a flowchart illustrating one embodiment of an algorithm for transferring messages between a vehicle communications network and a computer, in accordance with the present invention.

FIG. 4 is a flowchart illustrating one embodiment of an algorithm for transferring messages between a vehicle communications network and a computer, in accordance with the present invention.

FIG. 5 is a flowchart illustrating one embodiment of an algorithm for transferring messages between a vehicle communications network and a computer, in accordance with the present invention.

FIG. 6 is a flowchart illustrating one embodiment of an algorithm for transferring messages between a vehicle communications network and a computer, in accordance with the present invention.

FIG. 7 is a flowchart illustrating one embodiment of an algorithm for transferring messages between a vehicle communications network and a computer, in accordance with the present invention.

FIG. 8 is a flowchart illustrating one embodiment of an algorithm for transferring messages between a vehicle communications network and a computer, in accordance with the present invention.

FIG. 9 is a flowchart illustrating one embodiment of an algorithm for transferring messages between a vehicle communications network and a computer, in accordance with the present invention.

FIG. 10 is a flowchart illustrating one embodiment of an algorithm for transferring messages between a vehicle communications network and a computer, in accordance with the present invention.

FIG. 11 is a diagrammatic illustration of one embodiment of a communication network including a communications bridge system providing information exchange between one or more vehicle information networks and one or more remote systems or units.

FIG. 12 is a diagrammatic illustration of one embodiment of the communications bridge system of FIG. 11.

FIG. 13 is a diagrammatic illustration of a portion of the communications bridge system of FIG. 12 illustrating one embodiment of the indicator circuit, indicator driver circuit and operating voltage monitoring features thereof.

FIG. 14 is a diagrammatic illustration of another portion of the communications bridge system of FIG. 12 illustrating one embodiment of the connection interfaces between the DSP and the various communications transceivers.

FIG. 15 is a flowchart illustrating one embodiment of a process for transferring information from one or more vehicle communications networks to a remote system or unit, configured for communication according to a first remote system protocol, via the communications bridge system of FIGS. 11-14.

FIG. 16 is a flowchart illustrating one embodiment of a process for transferring information from the remote system, configured for communication according to the first remote system communication protocol, to the one or more vehicle communications networks via the communications bridge system of FIGS. 11-14.

FIG. 17 is a flowchart illustrating one embodiment of a process for transferring information from one or more vehicle communications networks to a remote system, configured for communication according to a second remote system protocol, via the communications bridge system of FIGS. 11-14.

FIG. 18 is a flowchart illustrating one embodiment of a process for transferring information from the remote system, configured for communication according to the second remote system communication protocol, to the one or more vehicle communications networks via the communications bridge system of FIGS. 11-14.

### DESCRIPTION OF THE ILLUSTRATIVE EMBODIMENTS

Illustrative embodiments of an adapter for use with a vehicle communications network are herein described. It will be appreciated by those skilled in the art that the device is useful in applications and embodiments differing from the description that follows.

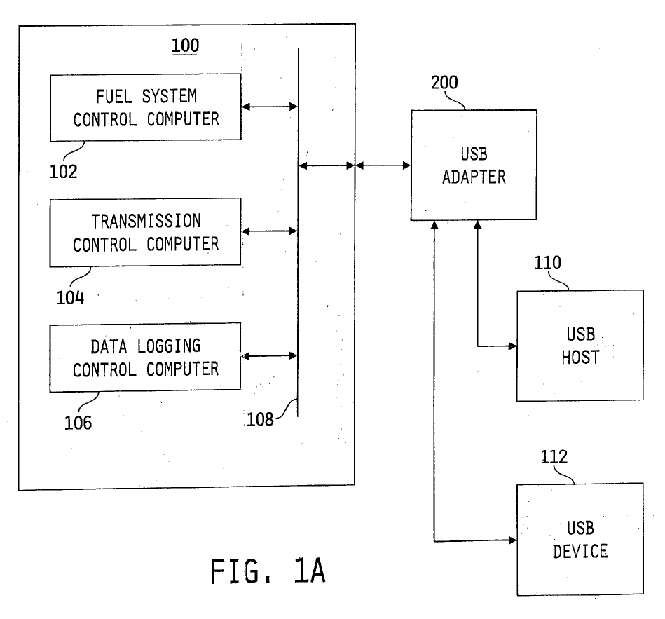

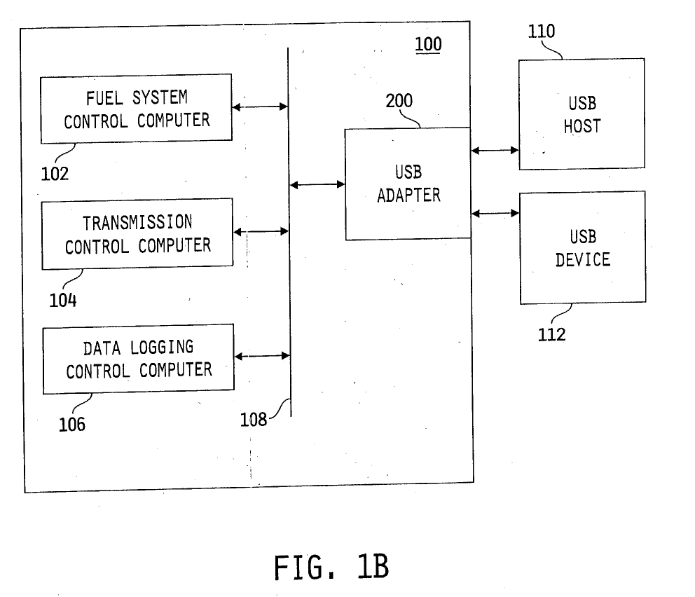

Referring now generally to FIG. 1A, one preferred embodiment of the present invention is shown. Vehicle control system 100 includes: fuel system control computer 102, transmission control computer 104, data logging control computer 106, and vehicle communications network 108. Those skilled in the art will recognize that vehicle control system 100 is simplified for illustration purposes, and could include a variety of other control computers, such as an anti-lock braking system (ABS) controller, an ignition system controller, and the like. Two items of service equipment, USB Host 110 and USB Device 112, are shown in communication with vehicle control system 100 via USB adapter 200, wherein USB adapter 200 is remotely located from vehicle control system 100.

Referring now generally to FIG. 1B, an alternate embodiment of the present invention is shown. As shown in FIG. 1B, in this alternate embodiment vehicle control system 100 includes USB adapter 200, in addition to fuel system control computer 102, transmission control computer 104, data logging control computer 106, and vehicle communications network 108. The two items of service equipment, USB Host 110 and USB Device 112, are shown in communication with vehicle control system 100 via USB adapter 200, wherein vehicle control system 100 incorporates USB adapter 200 integrated. Those skilled in the art will understand that the functionality of USB adapter 200 is independent from the physical location thereof.

Fuel system control computer 102 (also known as an engine control computer or an engine control module) provides a fueling signal to a fuel system, which regulates the fuel and air mixture available in the cylinders. As is known in the art, data such as a fueling map for the engine are programmed into fuel system control computer 102. Fuel system control computer 102 receives a torque request signal and various data regarding the current state of the vehicle and engine (such as engine speed and vehicle speed), and utilizes the fueling map and other stored data to calculate the fueling signal. Several elements of data are variable and may vary by application. For example, fuel system control computer 102 may contain variables for maximum engine speed and maximum vehicle speed. If a particular vehicle is, for example, a commercial truck, it may have the maximum vehicle speed variable set to 35 mph when used for local deliveries, and to 65 mph when used for long-haul deliveries. For a further example, the idle speed of the engine is often a variable, and may be adjusted according to preference.

Similarly, transmission control computer 104 provides a shift signal to an automatic transmission, which regulates the shifting of gears in the transmission. As is known in the art, data are also programmed into transmission control computer 104, and it receives various data regarding the current state of the vehicle and engine, and utilizes the stored data to calculate gear shifting. Several elements of data programmed into transmission control computer 104 are also variable, and may vary by application.

Data logging control computer 106 provides a mechanism for logging information regarding the operation of the vehicle. As is known in the art, data are also programmed into data logging control computer 106, and it receives various data regarding the current state of the vehicle, performs calculations where necessary, and stores the data. Several elements of data programmed into data logging control computer 106 are also variable, and may vary by application. For example, data logging control computer 106 may be coupled to a vehicular GPS receiver, and may log the location of the vehicle at some preprogrammed interval, such as every minute. In another example where data logging control computer 106 is coupled to a vehicular GPS receiver, it may compare the current vehicle location to a “map” containing allowable vehicle locations, and may only log “out-of-bounds” locations.

Vehicle communications network 108 is a collection of one or more computer networks that facilitate communications between network nodes. In this illustrative embodiment, fuel system control computer 102, transmission control computer 104, data logging control computer 106, and USB adapter 200 are the nodes between which data will be communicated. Because USB adapter 200 functions as a “bridge”, USB device(s) 112 and USB host 110 can also be considered network nodes of vehicle communications network 108.

The Society of Automotive Engineers (SAE) Truck and Bus Control and Communications Subcommittee has developed a family of standards concerning the design and use of devices that transmit electronic signals and control information between vehicle components. One such standard, known as SAE J1939, has become an accepted industry standard in heavy-duty vehicle communications network design. Other accepted industry standards are the SAE J1587 and J1850 standards. These standards are known to those skilled in the art. In one preferred embodiment, one or more segments of vehicle communications network 108 are J1939 and/or J1587 and/or J1850 compliant. However, vehicle communications network 108 may also support other known communication protocols, such as the ISO-9141 diagnostic interface standard or the Bosch Controller Area Network (CAN) 2.0 A and 2.0 B standards. Messages transmitted via vehicle communications network 108 are either “Addressed” to a specific node, or “broadcast” to one or more subnetworks. The methods of transmitting messages compliant with these protocols are well known in the art.

In one preferred embodiment, communications are carried out in accordance with published recommended practices known to those skilled in the art. For example, The Maintenance Council (TMC) established a standardized interface for vehicle computer communication and control, documented in TMC's RP1210 “Windows Communication Application Program Interface (API) Version A”. This Recommended Practice (RP) defines a communication Application Program Interface (API) between the on-vehicle data link and PC application software programs running under the Windows™ family of operating systems. This RP establishes a standard interface between the physical data link (J1708, CAN/J1939, or J1850) and Windows™ software applications for the personal computer. In other preferred embodiments, other recommended practices known to those skilled in the art are implemented.

USB adapter 200 (which is described in detail, below) acts as a network bridge between vehicle communications network 108 and USB Host 110 and USB device(s) 112. A network bridge is a device that allows two networks, even ones dissimilar in topology, wiring, or communications protocols, to exchange data. The concept of a network bridge is well known in the art. USB Host 110 may be any computer having a USB host controller, such as a standard PC. USB device(s) 112 may be any computer having a USB device controller, such as a commercially available PDA, or even a broadband (cable or DSL) internet modem. Currently, up to 127 USB device(s) 112 may be connected, provided that all devices do not rely on USB adapter 200 for power, and provided that bandwidth utilization is kept below the bandwidth of the implemented USB standard.

In one preferred embodiment, USB host 110 may be stationary service equipment, such as an engine analyzer. In another preferred embodiment, USB host 110 may be a maintenance log computer that downloads log information from data logging control computer 106. Essentially, USB host 110 may be any known portable service tool, or any computer configured to interface with the nodes of a vehicle communications network.

Similarly, USB device(s) 112 may be any computer configured to interface with the nodes of a vehicle communications network, such as a PDA configured to operate as a service tool. For example, a standard PDA may contain a variety of vehicle configurations which may be downloaded to vehicle control computers. This would allow a vehicle operator to receive an updated configuration file for a vehicle via, for example, an e-mail from the vehicle manufacturer, download the configuration file to a properly configured PDA, and then carry the PDA to his vehicle to install the update. This method would be advantageous for vehicle owners that do not possess an entire “bay” of engine service equipment, as it would eliminate the need to carry a cumbersome desktop or laptop computer to the vehicle. It is generally known that USB cable runs are limited to five meters, unless a repeater is used.

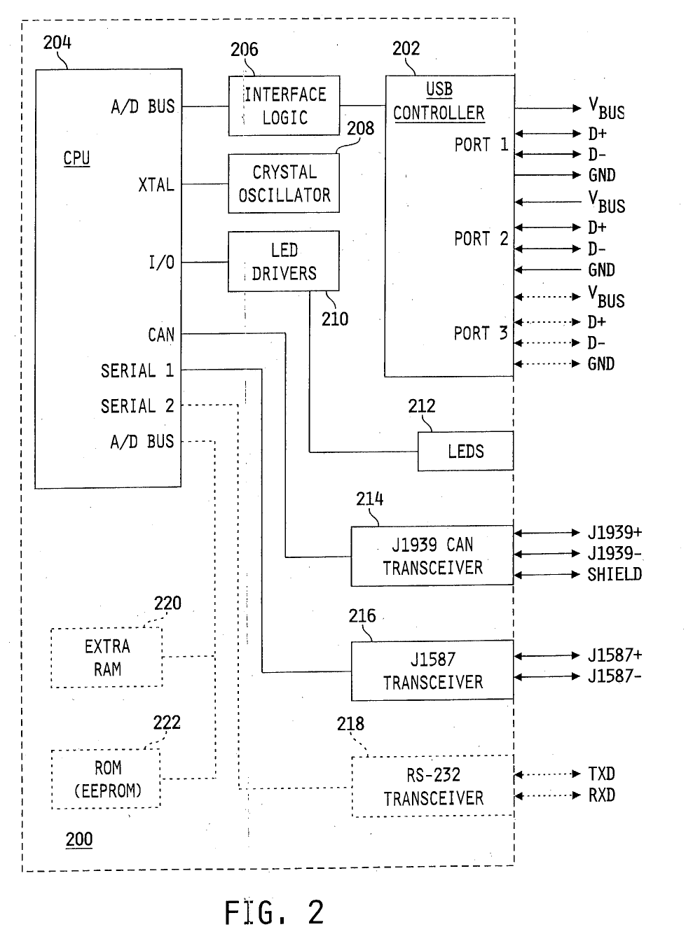

Referring now generally to FIG. 2, one preferred embodiment of USB adapter 200 is shown. USB adapter 200 includes: USB controller 202, central processing unit (CPU) 204, interface logic 206, crystal oscillator 208, light emitting diode (LED) drivers 210, LEDs 212, J1939 transceiver 214, J1587 transceiver 216, optional RS-232 transceiver 218, optional extra random access memory (RAM) 220, optional read only memory (ROM) 222, and a power supply (not shown).

In one preferred embodiment, USB controller 202 is a commercially available USB Host/Device Controller/Transceiver circuit, such as the OTG243 single chip USB host and device controller manufactured by TransDimension, Incorporated of Irvine, California, or such as the ISP1362 USB host and device controller manufactured by Royal Philips Electronics of the Netherlands. However, a custom very large scale integrated (VLSI) circuit or other proprietary circuit containing separate host and device controllers could be used to fulfill this function. USB controller 202 provides the proper interface and message protocol for communicating over a Universal Serial Bus. USB controller 202 provides both a host downstream port (Port 1) and a device upstream port (Port 2). Optionally, USB controller 202 may provide an On-The-Go USB port (Port 3), which acts as either a host or a device port depending on whether a “mini-A” or a “mini-B” plug is inserted into the port's “mini-AB” receptacle. In other preferred embodiments, the USB controller is implemented as an on-board peripheral internal to CPU 204. In yet other preferred embodiments, the USB transceiver is separate from the USB controller.

An On-The-Go USB port provides full functionality as a USB device, and limited functionality as a USB host. The primary intended use for an On-The-Go USB port is to allow two similar devices, such as two PDAs, to communicate directly with each other, as well as with a host. Essentially, for this to occur, one of the “devices” in a device-to-device link must temporarily act as a host. It may be desirable in certain embodiments to implement device and host functionality with only a single On-The-Go USB port (Port 3). It will be understood by those skilled in the art that utilizing a single On-The-Go USB port may be desirable in certain embodiments, that utilizing discrete host and device ports may be desirable in certain other embodiments, and that utilizing discrete host and device ports in conjunction with an On-The-Go port may be desirable in still other embodiments. It will also be understood by those skilled in the art that none of these embodiments depart from the scope of the invention disclosed herein.

Each USB port has an appropriate USB receptacle which includes Vbus and GND connections for power, data positive (D+) and data negative (D−) connections for data, an ID connection if there is On-The-Go functionality (not shown), and a shield connection (not shown). A USB hub may be connected to either port, although a self-powered hub is recommended for the host port because of limitations regarding how much power USB controller 202 can provide. Protection circuitry is included to prevent permanent damage to adapter 200 from some external fault conditions.

In one preferred embodiment, central processing unit (CPU) 204 comprises a microcontroller. However, in other embodiments CPU 204 could comprise a digital signal processor, a microprocessor, or some other circuit capable of carrying out computations. CPU 204 executes the software stored in on-board ROM or EPROM (not shown) or in optional remotely located ROM or EPROM 222. On-board or remotely located EPROM memory 222 could be Flash EPROM, EEPROM, or UV EPROM circuits. The software provides a means for performing the adapter functions. In one preferred embodiment, CPU 204 includes on-board random access memory (RAM) for executing software, and in other preferred embodiments USB adapter 200 includes optional off-board RAM 220.

The use of Flash EPROM and EEPROM memory for the on-board EPROM of CPU 204 or for EPROM 222 allows the software to be updated via one of the communications ports of adapter 200. Illustratively, a software update would be loaded onto an external computer, and that computer would communicate the updated software to adapter 200, where CPU 204 would execute an update algorithm to load the software into the Flash EPROM and EEPROM memory.

In one preferred embodiment, CPU 204 comprises a crystal oscillator input (XTAL), parallel address/data bus interface (A/D Bus), controller area network (CAN) interface, two serial communications interfaces (Serial 1, Serial 2), and digital input/output interfaces (I/O). These interfaces are configured to be interoperable with other elements of USB adapter 200 as follows.

The Crystal oscillator input (XTAL) of CPU 204 interfaces with crystal oscillator 208. Crystal oscillator 208 includes either separate crystals or a complete active oscillator circuit for providing the necessary oscillator input clocks to CPU 204 and the USB Controller 202. Alternatively, crystal oscillator 208 may be any clock circuit capable of generating the appropriate waveforms, as is known in the art.

The digital input/output interfaces (I/O) of CPU 204 interface with LED drivers 210. LED drivers 210 provide the necessary power to turn on LEDs 212. LEDs 212 indicate the operational status of the adapter 200, as well as the operational status of each of the communication networks. USB controller 202 may also interface with LED drivers 210 in order to provide an indication of the status of the universal serial busses, although the LEDs and their supporting hardware may not be included in all embodiments.

Regarding LEDs 212, in one preferred embodiment, one LED indicates that power is being applied to the USB adapter 200, while others indicate the status of communications over the universal serial busses, the J1939 network, the J1587 network, and the optional Electronics Industry Association (EIA) or Recommended Standards (RS) RS-232 (also known as EIA-232) serial communication link.

The CAN interface of CPU 204 interfaces with J1939 CAN transceiver 214. Transceiver 214 provides an interface between the CAN controller in CPU 204 and the J1939 data link of vehicle communications network 108. Transceiver 214 is compatible with SAE J1939 part 11 and part 15 hardware interface schemes, which are known in the art. Transceiver 214 also includes protection circuitry that prevents permanent damage to adapter 200 caused by certain external fault conditions. In other preferred embodiments, the CAN controller is implemented as an integrated circuit (IC) distinct from CPU 204. In this embodiment, the CAN controller IC is coupled between the A/D Bus or a serial bus of CPU 204 and CAN transceiver 214. In yet another preferred embodiment, the transceiver functionality of CAN transceiver 214 is integrated with a distinct CAN controller IC, and this single IC is coupled to the A/D Bus or a serial bus of CPU 204.

A first serial communications interface (Serial 1) of CPU 204 interfaces with J1587 transceiver 216. Transceiver 216 is an RS-485 (also known as EIA-485) transceiver circuit that conforms to the SAE J1708 hardware interface standard, as is known in the art. The J1708 standard is based on the RS-485 interface standard. Because both the SAE J1587 and the SAE J1922 standards are based on the J1708 interface, both J1922 and J1587 messages can also be received and transmitted via J1587 transceiver 216.

Transceiver 216 provides the interface between a first serial communications interface (otherwise known as a universal asynchronous receiver transmitter or UART) in CPU 204 and a J1708/J1587 and/or a J1708/J1922 data link of vehicle communications network 108. Those skilled in the art will recognize that the UART may be of conventional design or may alternatively comprise a number of discrete I/O pins used in a so-called “bit bang” mode wherein the I/O lines are toggled on and off to mimic the serial data stream of a conventional UART. In any case, transceiver 216 also includes protection circuitry that prevents permanent damage to adapter 200 caused by certain external fault conditions. In other preferred embodiments, the UART may exist as a distinct IC outside of CPU 204, in which case the UART would be coupled between CPU 204 and J1587 transceiver 216. In yet another preferred embodiment, the transceiver functionality of J1587 transceiver 216 is integrated with a distinct UART IC, and this single IC is coupled to CPU 204.

In one preferred embodiment, a second serial communications interface (Serial 2) of CPU 204 interfaces with optional RS-232 transceiver 218. Optional RS-232 transceiver 218 provides an interface between a second serial communications interface (otherwise known as a universal asynchronous receiver transmitter or UART) in CPU 204 and a serial port of another computer system, such as a PC or PDA. Transceiver 218 also includes protection circuitry that prevents permanent damage to adapter 200 caused by certain external fault conditions. In other preferred embodiments, the UART may exist as a distinct IC outside of CPU 204, in which case the UART would be coupled between CPU 204 and RS-232 transceiver 218. In yet another preferred embodiment, the transceiver functionality of RS-232 transceiver 218 is integrated with a distinct UART IC, and this single IC is coupled to CPU 204.

In one preferred embodiment, the address/data bus interface (A/D Bus) of CPU 204 interfaces to optional ROM 222 via addressing interface logic (not shown). ROM 222 utilizes either ROM or EPROM memory for storing software, or other parameters. EPROM memory may be Flash EPROM, EEPROM, UV EPROM circuits, or any other type of erasable ROM.

In one preferred embodiment, the address/data bus interface (A/D Bus) of CPU 204 interfaces to optional extra RAM 220 via addressing interface logic (not shown). Extra RAM 220 may be used for executing software, or for storing data while power is applied.

In one preferred embodiment, the address/data bus interface (A/D Bus) of CPU 204 interfaces to interface logic 206, as necessary. Interface logic 206 provides the proper interface and timing requirements between the parallel address/data bus and/or control signals of CPU 204 and USB controller 202. The use of interface logic to connect devices to CPUs is known in the art. In other preferred embodiments, interface logic may not be required in an interface between the parallel address/data bus and/or control signals of CPU 204 and USB controller 202. In still other preferred embodiments, the interface between CPU 204 and USB controller 202 may be a serial interface, such as a Serial Peripheral Interface (SPI).

In one preferred embodiment, USB adapter 200 includes a power supply circuit (not shown) that provides the optional Flash memory programming voltage (Vpp), optional 3.3-Volt power, and 5-Volt power to all of the internal circuitry. This power supply circuit may also provide the 5-Volt power to the downstream USB Vbus in the Port 1. Furthermore, this power supply circuit may provide an optional external trickle charge voltage for charging rechargeable PDA batteries. The power supply circuit may be compatible with 12-Volt, 24-Volt, and future 42-Volt vehicle electrical systems. The power may be provided from the vehicle via a vehicle data link connector, the vehicle cigarette lighter, or some other means. An alternative source of power could come from the Vbus of a connected USB Host. USB adapter 200 may also include optional internal batteries that supply power to the Adapter, or the adapter may receive power from an external or internal AC-to-DC power supply when AC power is available. Where internal or external batteries are utilized, in one illustrative embodiment, a low-power “sleep” mode is implemented. The low-power “sleep” mode engages when no communications activity is detected for a set period of time, in order to prevent the batteries from being drained when the adapter is not in use.

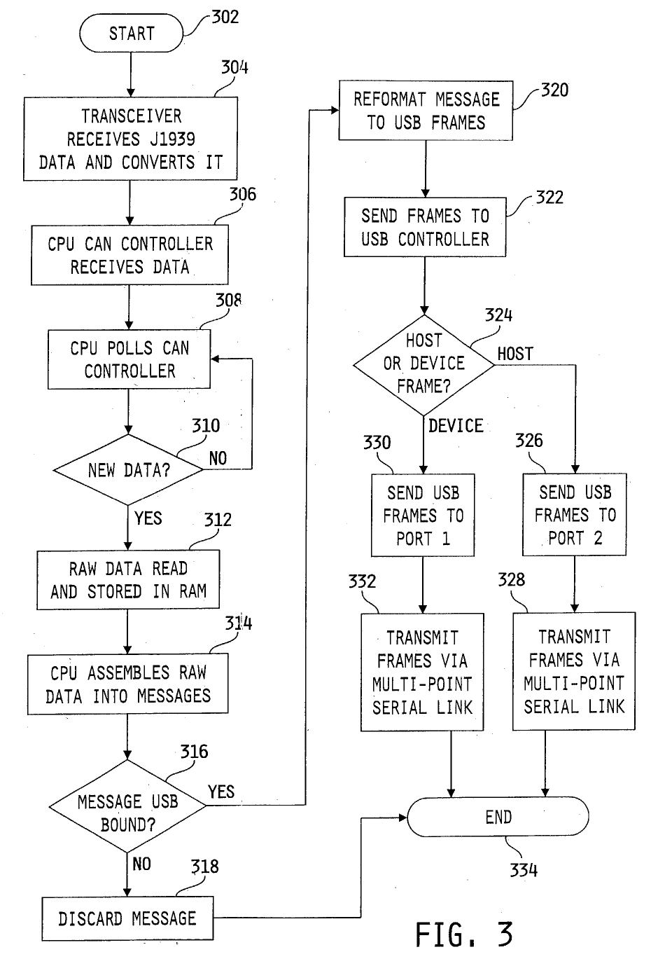

Reference is now made to FIGS. 3-10, which illustrate examples of algorithms executed by USB adapter 200. The eight interfaces (J1939 to USB, USB to J1939, J1587 to USB, USB to J1587, J1939 to RS-232, RS-232 to J1939, J1587 to RS-232, and RS-232 to J1587) are discussed individually below. Those skilled in the art will recognize that the algorithms described herein are illustrative, and that other algorithms could be implemented without departing from the scope of the invention.

Turning to FIG. 3, a flow chart that illustrates one preferred embodiment of an algorithm to implement the J1939 to USB interface is shown. The algorithm begins at step 302. In step 304, serial information from the J1939 portion of vehicle communications network 108 containing network messages first enters J1939 transceiver 214 over lines J1939+ and J1939−. Transceiver 214 converts the data signal as required for it to be read by the CAN interface of CPU 204. In step 306, the data signal is received by a CAN controller associated with the CAN interface of CPU 204. In steps 308-310, CPU 204 polls the CAN controller in a continuous polling cycle. (The complete polling cycle includes polling all other interfaces, as well.) During each cycle, in step 312 any new raw data is read and stored in a RAM associated with CPU 204. Alternatively, CPU 204 may respond to an interrupt generated when data is received by the CAN controller. Both polling software and interrupt handlers are well known in the art, and those skilled in the art will recognize that either method could be implemented without departing from the scope of the invention.

In step 314, CPU 204 assembles the raw data into messages, and in step 316 it determines if a message is bound for USB host 110 or one of USB devices 112. If the message is not bound for a USB host 110 or one of USB devices 112, then in step 318 the message is discarded. Otherwise, in step 320 CPU 204 reformats the message as one or more properly addressed USB frames.

In step 322, the USB frames are sent from the A/D bus interface of CPU 204 to USB controller 202, which communicates them to the appropriate port (Port 1 for devices, and Port 2 for a host) in steps 324 and step 326 or step 330. In step 332 or step 328, the USB frames are sent from the appropriate port of USB controller 202 via the USB serial link to USB host 110 or USB device 112, in accordance with the address of each USB frame.

Optionally, if the controller includes an On-The-Go Port 3, USB controller 202 communicates the USB frames to Port 3 where appropriate (not shown). The frames are then sent from the Port 3 of USB controller 202 via the USB serial link to USB host 110 or USB device 112, in accordance with the address of each USB frame. At step 334, the algorithm ends, and returns to “Start” step 302.

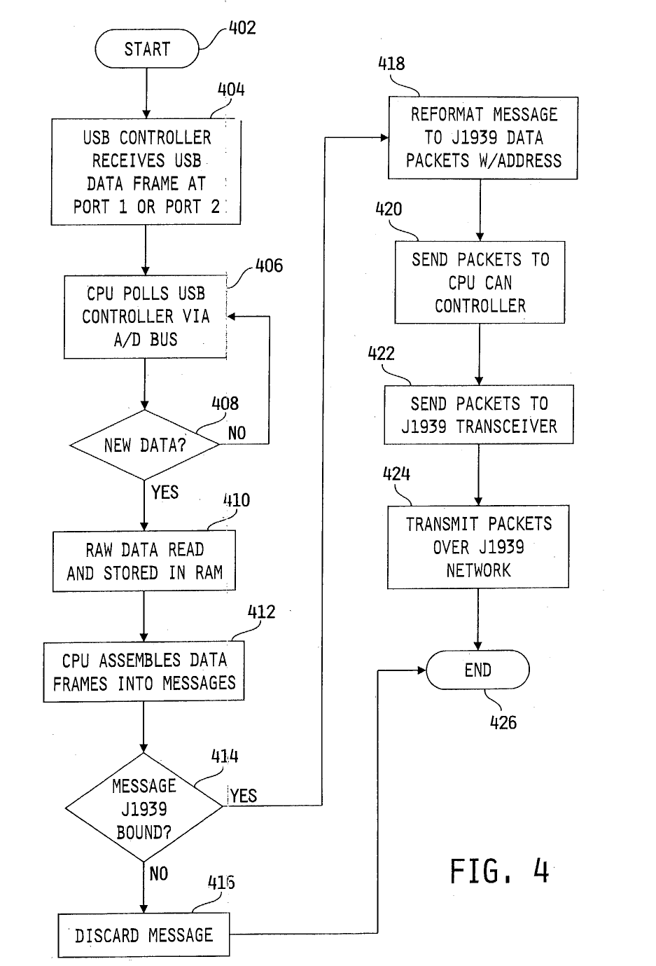

Turning to FIG. 4, a flow chart that illustrates one preferred embodiment of an algorithm to implement the USB to J1939 interface is shown. The algorithm begins at step 402. In step 404, a USB data frame from the USB serial link enters either Port 1 or Port 2 of USB controller 202. Optionally, if the controller includes an On-The-Go Port 3, a USB data frame from the USB serial link may enter Port 3 of USB controller 202 (not shown). In steps 406-408, CPU 204 polls USB controller 202 in a continuous polling cycle. During each cycle, in step 410 any new data frame is read and stored in a RAM associated with CPU 204. Alternatively, CPU 204 may respond to an interrupt generated when data is received by USB controller 202.

In step 412, CPU 204 assembles the data frames into messages, and in step 414 it determines if a message is addressed to a J1939 node of vehicle communications network 108. If not, then in step 416 the message is discarded. Otherwise, in step 418 CPU 204 reformats the message as one or more properly addressed J1939 data packets. In step 420, the J1939 data packets are sent to the CAN controller of CPU 204, and in step 422 the data packets are sent to J1939 transceiver 214. In step 424, transceiver 214 communicates these data packets to the appropriate node of vehicle communications network 108 via the J1939+ and J1939-network lines coupled thereto, in accordance with the address of the data packet. At step 426, the algorithm ends, and returns to “Start” step 402.

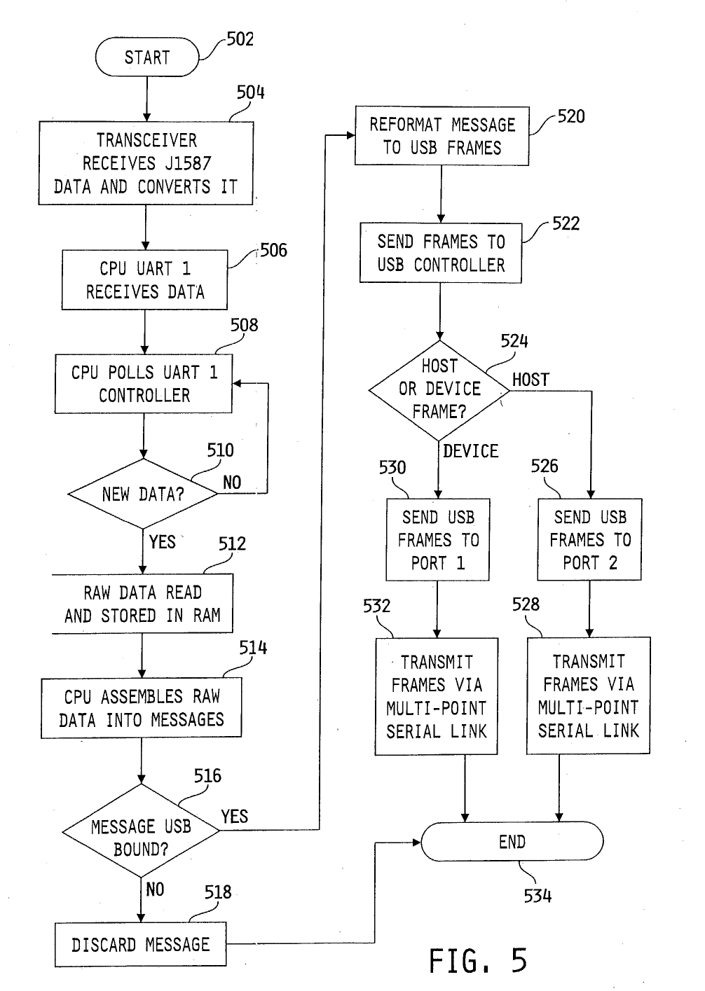

Turning to FIG. 5, a flow chart that illustrates one preferred embodiment of an algorithm to implement the J1587 to USB interface is shown. The algorithm begins at step 502. In step 504, serial information from the J1587 portion of vehicle communications network 108 containing network messages first enters J1587 transceiver 216 over lines J1587+ and J1587−. Transceiver 216 converts the data signal as required for it to be read by the UART associated with the Serial 1 interface of CPU 204. In step 506, the data signal is received by the UART associated with the Serial 1 interface of CPU 204. In steps 508-510, CPU 204 polls the UART in a continuous polling cycle. During each cycle, in step 512 any new raw data is read and stored in a RAM associated with CPU 204. Alternatively, CPU 204 may respond to an interrupt generated when data is received by the UART.

In step 514, CPU 204 assembles the raw data into messages, and in step 516 determines if a message is bound for USB host 110 or one of USB devices 112. If not, then in step 518 the message is discarded. Otherwise, in step 520 CPU 204 reformats the message as one or more properly addressed USB frames. In step 522, the USB frames are sent from the A/D bus interface of CPU 204 to USB controller 202, which communicates them to the appropriate port (Port 1 for devices, and Port 2 for a host) in steps 524 and either step 526 or step 530. In step 528 or step 532, the USB frames are sent from the appropriate port of USB controller 202, via the USB serial link, to USB host 110 or USB device 112, in accordance with the address of the USB data frame.

Optionally, if the controller includes an On-The-Go Port 3, USB controller 202 communicates the USB frames to Port 3 where appropriate (not shown). The frames are then sent from the Port 3 of USB controller 202 via the USB serial link to USB host 110 or USB device 112, in accordance with the address of each USB frame. At step 534, the algorithm ends, and returns to “Start” step 502.

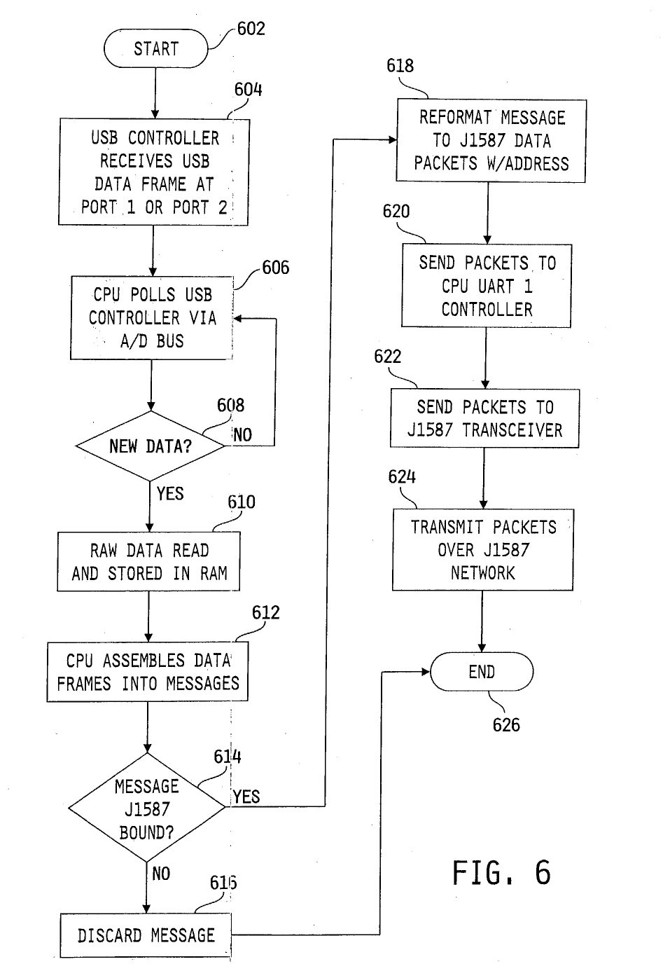

Turning to FIG. 6, a flow chart that illustrates one preferred embodiment of an algorithm to implement the USB to J1587 interface is shown. The algorithm begins at step 602. In step 604, serial information from the USB serial link first enters either Port 1 or Port 2 of USB controller 202 as USB data frames. Optionally, if the controller includes an On-The-Go Port 3, a USB data frame from the USB serial link may enter Port 3 of USB controller 202 (not shown). In steps 606-608, CPU 204 polls USB controller 202 in a continuous polling cycle. During each cycle, in step 610 any new data frame is read and stored in a RAM associated with CPU 204. Alternatively, CPU 204 may respond to an interrupt generated when data is received by USB controller 202.

In step 612, CPU 204 assembles the data frames into messages, and in step 614 determines if a message is addressed to a J1587 node of vehicle communications network 108. If not, then in step 616 the message is discarded. Otherwise, in step 618 CPU 204 reformats the message as one or more properly addressed J1587 data packets. In step 620, the J1587 data packets are sent to the UART associated with the Serial 1 interface of CPU 204. In step 622, the J1587 data packets are sent to J1587 transceiver 216. In step 624, transceiver 216 communicates these data packets to the appropriate node of vehicle communications network 108 via the J1587+ and J1587-lines coupled thereto, in accordance with the address of the data packet. At step 626, the algorithm ends, and returns to “Start” step 602.

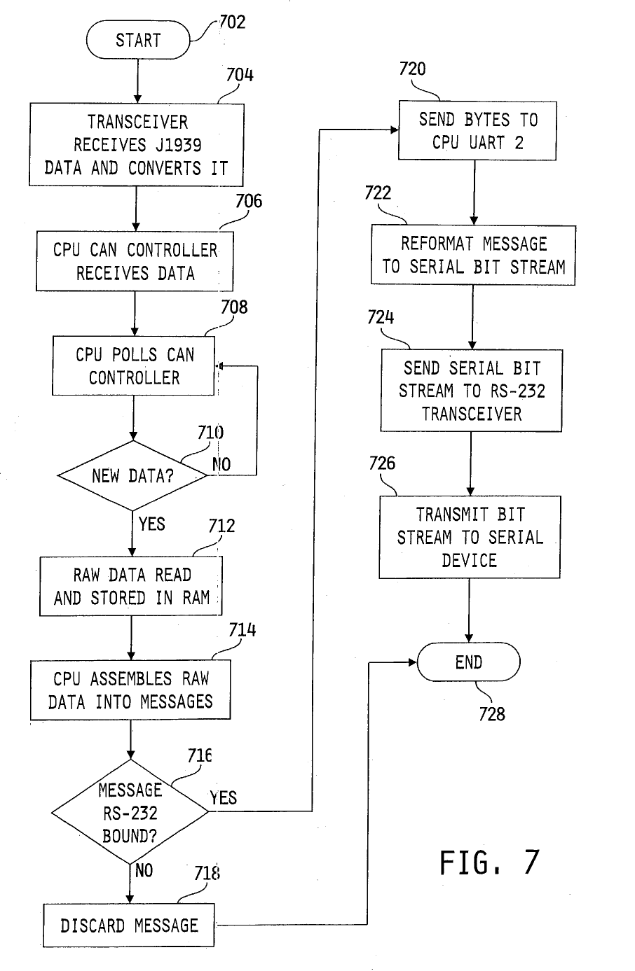

Turning to FIG. 7, a flow chart that illustrates one preferred embodiment of an algorithm to implement the optional J1939 to RS-232 interface is shown. The algorithm begins at step 702. In step 704, serial information from the J1939 portion of vehicle communications network 108 containing network messages first enters J1939 transceiver 214 over lines J1939+ and J1939− thereof. Transceiver 214 converts the data signal as required for it to be read by the CAN interface of CPU 204. In step 706, the data signal is received by a CAN controller associated with the CAN interface of CPU 204. In steps 708-710, CPU 204 polls the CAN controller in a continuous polling cycle. During each cycle, in step 712 any new raw data is read and stored in a RAM associated with CPU 204. Alternatively, CPU 204 may respond to an interrupt generated when data is received by the CAN controller.

In step 714, CPU 204 assembles the raw data into messages, and in step 716 determines if a message is bound for a serial device coupled to RS-232 transceiver 218. If not, then in step 718 the message is discarded. Otherwise, in step 720 the bytes of the message are sent to the UART associated with the Serial 2 interface of CPU 204. In step 722, the UART reformats the message into a serial bit stream. In step 724, the serial bit stream is sent from the UART associated with the Serial 2 interface of CPU 204 to RS-232 transceiver 218. In step 726, RS-232 transceiver 218 transmits the serial bit stream to the serial device coupled thereto via the TXD line of transceiver 218. At step 728, the algorithm ends, and returns to “Start” step 702.

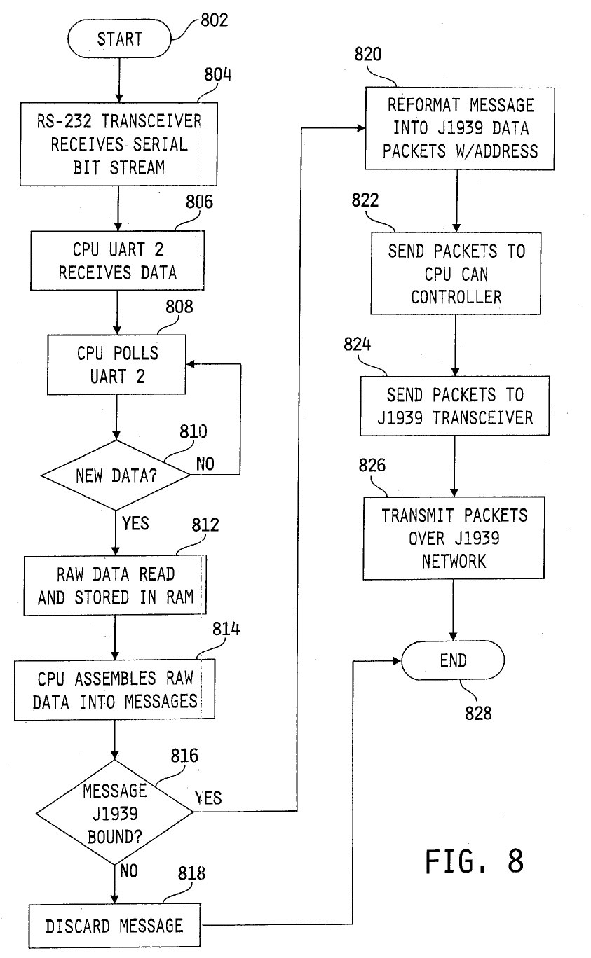

Turning to FIG. 8, a flow chart that illustrates one preferred embodiment of an algorithm to implement the optional RS-232 to J1939 interface is shown. The algorithm begins at step 802. In step 804, serial information from the serial device coupled to RS-232 transceiver 218 enters transceiver 218 on line RXD as a serial bit stream, and in step 806 is immediately transferred to the UART associated with the Serial 2 interface of CPU 204. The UART converts the serial bit stream to bytes, and stores the bytes in a buffer. In steps 808-810, CPU 204 polls the UART in a continuous polling cycle. During each cycle, in step 812 any new bytes are read and stored in a RAM associated with CPU 204. Alternatively, CPU 204 may respond to an interrupt generated when data is received by the UART.

In step 814, CPU 204 assembles the bytes into messages, and in step 816 it determines if a message is addressed to a J1939 node of vehicle communications network 108. If not, then in step 818 the message is discarded. Otherwise, in step 820 CPU 204 reformats the message as one or more properly addressed J1939 data packets. In step 822, the J1939 data packets are sent to the CAN controller of CPU 204. In step 824, the J1939 data packets are sent to J1939 transceiver 214. In step 826, transceiver 214 communicates the data packets to the appropriate node of vehicle communications network 108, in accordance with the address of the data packet. At step 828, the algorithm ends, and returns to “Start” step 802.

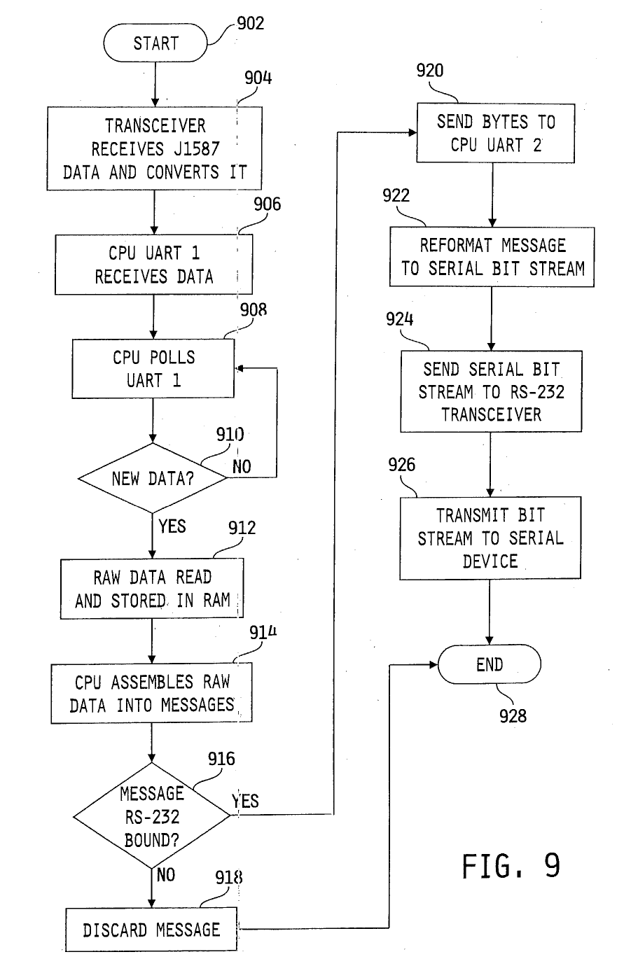

Turning to FIG. 9, a flow chart that illustrates one preferred embodiment of an algorithm to implement the optional J1587 to RS-232 interface is shown. The algorithm begins at step 902. In step 904, serial information from the J1587 portion of vehicle communications network 108 containing network messages first enters J1587 transceiver 216 over lines J1587+ and J1587− thereof. Transceiver 216 converts the data signal as required for it to be read by the UART associated with the Serial 1 interface of CPU 204. In step 906, the data signal is received by the UART associated with the Serial 1 interface of CPU 204. In steps 908-910, CPU 204 polls the UART in a continuous polling cycle. During each cycle, in step 912 any new raw data is read and stored in a RAM associated with CPU 204. Alternatively, CPU 204 may respond to an interrupt generated when data is received by the UART.

In step 914, CPU 204 assembles the raw data into messages, and in step 916 it determines if a message is bound for a serial device coupled to RS-232 transceiver 218. If not, then in step 918 the message is discarded. Otherwise, in step 920 the bytes of the message are sent to the UART associated with the Serial 2 interface of CPU 204. In step 922, the UART reformats the message into a serial bit stream. In step 924, the serial bit stream is sent from the UART associated with the Serial 2 interface of CPU 204 to RS-232 transceiver 218. In step 926, transceiver 218 transmits the serial bit stream to the serial device coupled thereto via the TXD line of transceiver 218. At step 928, the algorithm ends, and returns to “Start” step 902.

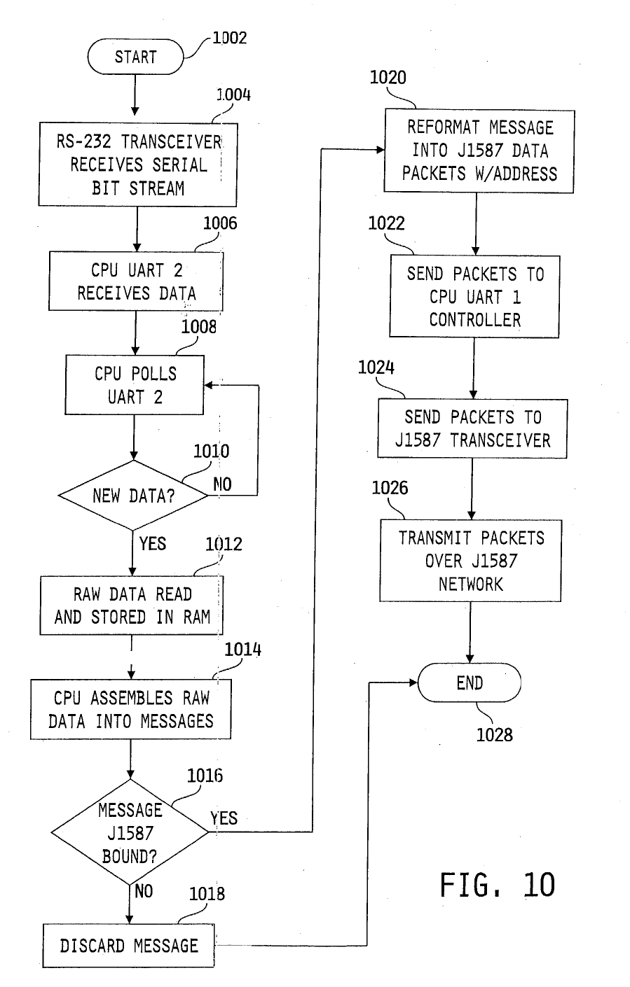

Turning to FIG. 10, a flow chart that illustrates one preferred embodiment of an algorithm to implement the optional RS-232 to J1587 interface is shown. The algorithm begins at step 1002. In step 1004, serial information from the serial device coupled to RS-232 transceiver 218 enters transceiver 218 as a serial bit stream, and in step 1006 is immediately transferred to the UART associated with the Serial 2 interface of CPU 204. The UART converts the serial bit stream to bytes, and stores the bytes in a buffer. In steps 1008-1010, CPU 204 polls the UART in a continuous polling cycle. During each cycle, in step 1012 any new bytes are read and stored in a RAM associated with CPU 204. Alternatively, CPU 204 may respond to an interrupt generated when data is received by the UART.

In step 1014, CPU 204 assembles the bytes into messages, and in step 1016 it determines if a message is addressed to a J1587 node of vehicle communications network 108. If not, then in step 1018 the message is discarded. Otherwise, in step 1020 CPU 204 reformats the message as one or more properly addressed J1587 data packets. In step 1022, the J1587 data packets are sent to the UART associated with the Serial 1 interface of CPU 204. In step 1024, the J1587 data packets are sent to J1587 transceiver 216. In step 1026, transceiver 216 communicates the data packets to the appropriate node of vehicle communications network 108 via the J1587+ and J1587− lines coupled thereto, in accordance with the address of the data packet. At step 1028, the algorithm ends, and returns to “Start” step 1002.

Other embodiments of the present invention may also be implemented without departing from the scope of the claimed invention. For example, in one illustrative embodiment it may be desirable to include in USB adapter 200 capability for downloading the updated calibration software from a remote computer to a vehicle subsystem computer. For further example, this disclosure primarily discusses engine control computers. However, in other illustrative embodiments USB adapter 200 may be used to interface remote computers to other vehicle subsystems, such as applications involving transmissions , anti-lock braking systems, vehicle management computers, and the like.

In the disclosure above, it is noted that PCs generally run vehicle diagnostic software while PDAs generally run service tool software. However, this is not necessarily the case, and nothing in this disclosure should be read to limit the software which may be executed by any remote computer coupled to a vehicle communications network in accordance with the present invention. Furthermore, almost any computer having the necessary communications capabilities may be coupled to vehicle communications network 108 via USB adapter 200, and nothing in this disclosure should be construed as implying otherwise.

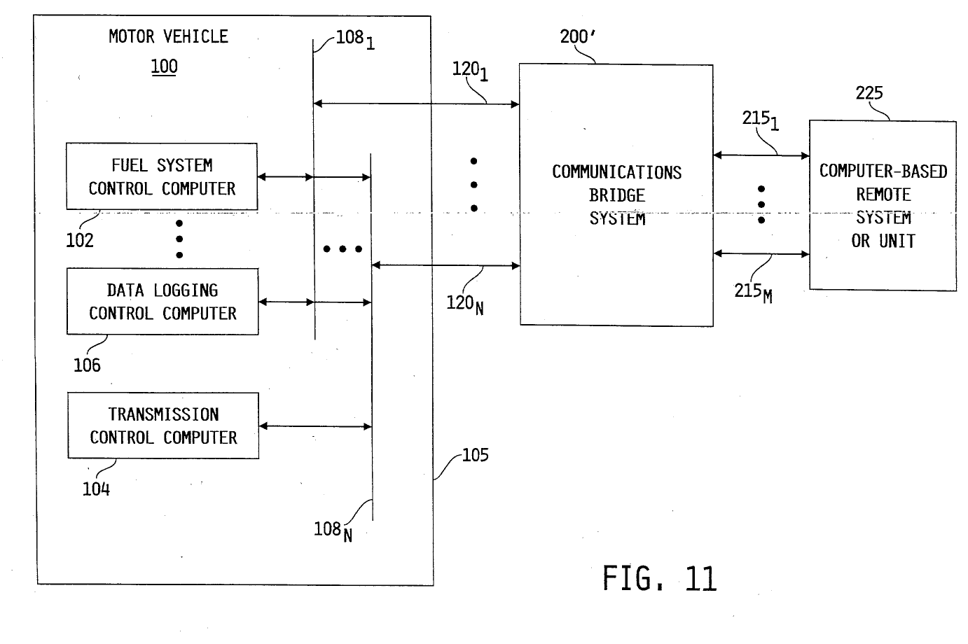

Referring now to FIG. 11, a diagrammatic illustration of another embodiment of a communication network including a communications bridge 200′ providing information exchange between one or more vehicle communications networks 108₁-108_{N} and a remote system 225, wherein N may be any positive integer, is shown. The one or more communications networks 108₁-108_{N} are carried by a motor vehicle 105 including a vehicle control system 100 as described hereinabove. The vehicle control system 100 may comprise any number of control computers, each operable to control one or more functions associated with the vehicle 105 and/or engine carried thereby, and any of the number of control computers may be operatively connected to any one or more of the vehicle communications networks 108₁-108_{N}. As illustrated in FIG. 11, for example, the vehicle control system may include at least a fuel system control computer 102, a transmission control computer 104 and a data logging control computer 106 as described hereinabove with respect to FIG. 1.

In the example shown, vehicle 105 includes two vehicle communications networks, and N is therefore 2. Vehicle communications network 108₁ is a society of automotive engineers (SAE) J1708 hardware communications structure that is a specific implementation of a general RS-485 hardware structure, which supports communications configured according to an established SAE J1587 communications protocol as is known in the art and as at least partially described hereinabove. Vehicle communications network 108₂, on the other hand, is an SAE J1939 hardware communications structure which supports communications configured according to an established SAE J1939 communications protocol as is known in the art and as at least partially described hereinabove. In this example, the fuel system control computer 102, which may be typically referred to in the engine control industry as an electronic or engine control module (ECM), and the data logging control computer 106, are both operatively connected in communication with each of the SAE J1708 and SAE J1939 communications networks. The transmission control computer 104, on the other hand, is operatively connected in communication only with the SAE J1939 communications network. Those skilled in the art will recognize other connection arrangements of any of the control computers 102, 104 and 106 relative to the SAE J1708 and SAE J1939 communications networks, and that vehicle 105 may carry one or more alternative or additional control computers that may be operatively connected in communication with either one or both of the SAE J1587 and/or SAE J1939 communications networks. Moreover, it is contemplated that the motor vehicle 105 may alternatively or additionally include other known vehicle communications networks, and that any one or more of the control computers carried by the motor vehicle 105 may be operatively connected in communication with any one or more such alternative or additional vehicle communications networks. Any such alternative connections and/or alternative or additional control computers and/or alternative or additional vehicle communications networks are intended to fall within the scope of the claims appended hereto.

The communication bridge system 200′ is RP-1210 compliant as described hereinabove. It is configured for connection to the one or more vehicle communication networks 108₁-108_{N} carried by the motor vehicle 105 via corresponding signal paths 120₁-120_{N}, and is configured for connection to a computer-based remote system or unit 225 via any one or more of a number, M, of signal paths 215₁-215_{M}, wherein M may be any integer. The computer-based remote system or unit 225 may be any computer-based system, unit or device configured for communication externally thereto via one or more known communications protocols, and in this regard the one or more communications paths 215₁-215_{M} include correspondingly one or more appropriately configured communications hardware or wireless structure(s) configured for communications according to the one or more communications protocols. Examples of the computer-based remote system or unit 225 include, but are not limited to, any known personal computer (PC), hand-held personal digital assistant (PDA), so-called pocket-PC, or the like. Examples of communications protocols used by such computer-based remote systems or units 225 include, but are not limited to, RS-232, universal serial bus (USB), wireless communications such as those configured in accordance with 802.11 standards or Bluetooth, or the like. The computer-based system or unit 225 may be configured for external communication via any one or more such communications protocols, and the choice of one or more hardware or wireless connections (any one or more of 215₁-215_{M}) between the system or unit 225 and the communications bridge system 200′ will be defined thereby.

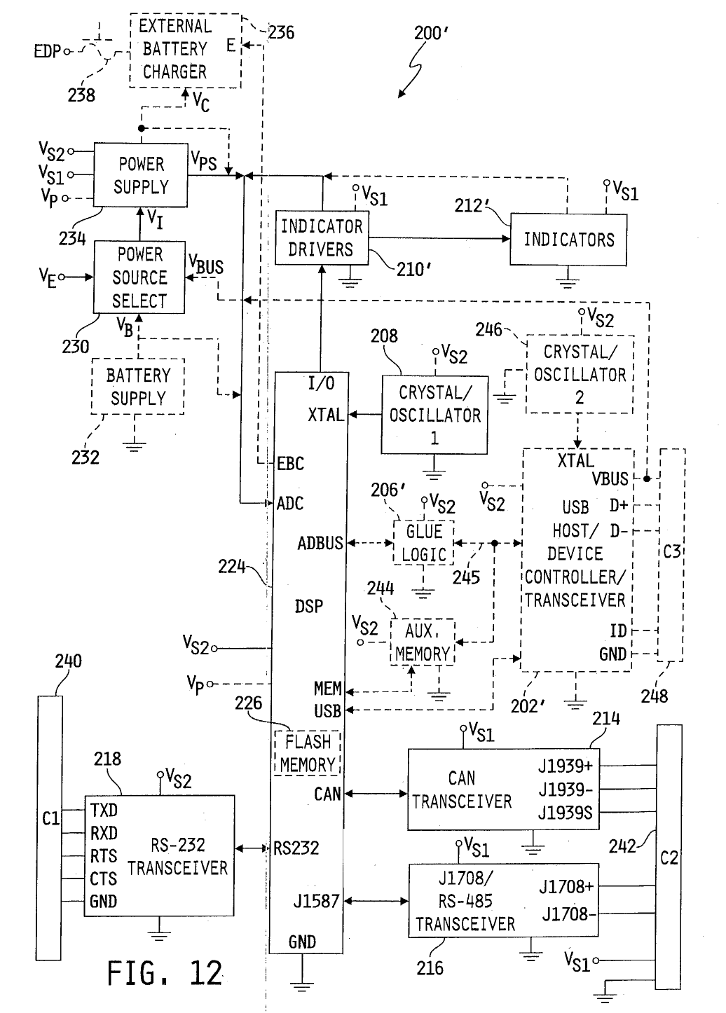

Referring now to FIG. 12, one illustrative embodiment of the communication bridge system 200′ of FIG. 11 is shown. The communications bridge system 200′ illustrated in FIG. 12 is configured for connection to the SAE J1708 communications network and to the SAE J1939 communications network of the motor vehicle 105, to an RS-232 port of the computer-based remote system or unit 225, and optionally to a USB port of the computer-based remote system or unit 225 as illustrated in phantom in FIG. 12. In this embodiment, the communications bridge system 200′ is configured for communication with the vehicle communication system 100 simultaneously via the SAE J1587 and J1939 communications networks, and for communication with the computer-based remote system 225 via an RS-232 and/or USB connection thereto.

The communications bridge system 200′ illustrated in FIG. 12 is similar in some respects to the communications adapter 200 illustrated and described hereinabove with respect to FIG. 2, and like numbers will therefore be used to identify like components. However, one substantial difference between the communications adapter 200 and the communications bridge system 200′ of FIG. 12 is that the communications bridge system 200′ is controlled by a digital signal processor (DSP) 224 rather than a microprocessor. The DSP 224 executes the firmware code required to perform all the operations and functions of the communications bridge system 200′. Included in the DSP circuit 224 are a central processor and non-volatile memory, volatile memory (RAM), crystal/oscillator input, parallel address/data bus, CAN controller, serial communications controllers, Analog-to-Digital converter, and general purpose digital inputs/outputs, as will be described in greater detail hereinafter. Besides processing data from the various vehicle communications networks, DSP 224 controls the state of output signals to change the on/off states of status indicators and measures inputs that indicate the voltage levels from various power supply voltages of interest and the diagnostic states of the indicator output drivers. System 200′ further includes a first crystal/oscillator circuit 208 configured to generate a first clock signal and provide this clock signal to a clock input, XTAL, of DSP 224. The crystal/oscillator circuit 208 may be configured to supply DSP 224 with a clock signal of any desired frequency, in a manner well-known in the art.

In one illustrative embodiment, the DSP 224 is a Motorola DSP56F807 16-bit digital signal processor, although it is contemplated that other known digital signal processors may be used. The DSP56F807 is a member of the DSP56800 core-based family of Motorola Digital Signal Processors, and combines on a single chip the processing power of a DSP and the functionality of a microcontroller with a flexible set of peripherals. The DSP56F807 processor core is based on a Harvard-style architecture comprising three execution units operating in parallel, thereby allowing execution of as many as six operations per instruction cycle. Thus, for example, using only two of the parallel execution units, a program instruction may be fetched by the program controller of the DSP56F807 while two addressed for the next instruction are generated by its address generation unit (AGU) and a mathematical operation is performed in its data arithmetic logic unit (ALU). The processing speed provided by the parallel instruction execution capabilities of the DSP 224 allows it to process multiple, real-time mathematical operations per instruction cycle, and to convert and transmit multiple-frame data messages without experiencing faults or failures. In this embodiment of the DSP 224, the crystal/oscillator circuit 208 is configured to supply an 8 MHz clock signal to the XTAL input of DSP 224, wherein DSP 224 is operable to multiply and divide the clock signal as necessary to provide appropriate internal clock signals.

DSP 224 includes internal program and data RAM (not shown), and may include internal flash memory 226 as shown in phantom in FIG. 12. It may also be desirable to include within system 200′ additional RAM external to the DSP 224, and in such embodiments DSP 224 is accordingly capable of supporting such external memory. The DSP56F807, for example, includes 2K×16-bit words of program RAM, 8K×16-bit words of data RAM, 60K×16-bit words of program flash, 8K×16-bit words of data flash and 2K×16-bit words of boot flash memory, wherein the flash memory is programmable via the USB controller 202′ as will be described in greater detail hereinafter, and supports up to 64K×16-bit words each of external program and data memory. The DSP56F807 is capable of processing up to 40 million instructions per second (MIPS) at an 80 MHz core frequency. Further details relating to the technical capabilities and features of the DSP56F807 are set forth in the DSP56F807 Technical Data Manual, Rev. 8.0, November 2002, available from Motorola, Inc., the contents of which are incorporated herein by reference.

The communications bridge system 200′ includes a power source select circuit 230 of known construction and operable to provide an input voltage, V₁, to a power supply 234, also of known construction, based on selection of any one of a number of source voltage inputs thereto. In the embodiment illustrated in FIG. 12, the power source select circuit 230 includes a first source voltage input receiving an externally generated voltage, V_{E}. The external voltage, V_{E}, may be provided from any suitable DC voltage source including for example, but not limited to, the vehicle battery or batteries (e.g., via one of the vehicle communication networks 108₁-108_{N}, via a known cigarette lighter adapter, or the like), another auxiliary battery or battery pack, a conventional plug-in AC-to-DC power supply, or the like. In embodiments where V_{E} is the only available source voltage to system 200′, the power source select circuit 230 may be omitted and V_{E} supplied directly as the input voltage, V₁, to the power supply 234.

System 200′ may optionally include an internal battery supply 232, as shown in phantom in FIG. 12, supplying a battery voltage, V_{B}, to the power source select circuit 230. The internal battery supply 232 may include one or more chargeable or non-chargeable batteries or battery packs of conventional construction. In embodiments of system 200′ including a USB host/device controller/transceiver 202′, as shown in phantom in FIG. 12, such a device will typically include a voltage bus (VBUS) port configured for connection to a corresponding VBUS port of the remote system or unit 225. In such embodiments, the VBUS voltage may be supplied by the remote system or unit 225 as another source voltage input to the power source select circuit 230, as shown in phantom in FIG. 12. Alternatively, although not specifically shown in the drawings, the power supply 234 may be configured to supply the VBUS voltage to both the USB host/device controller transceiver 202′ and to the remote system or unit 225. In any case, those skilled in the art will recognize other known DC voltage sources that may be used to provide additional source voltage inputs to the power source select circuit 230 of system 200′, and any such other known DC voltage sources are intended to fall within the scope of the claims appended hereto. The power source select circuit 230 may further include a manually operated switch (not shown) allowing selection of an appropriate one of the number of source voltage inputs as the input voltage, V₁, to the power supply 234.

The power supply 234 is a conventional power supply circuit operable to produce at least a first supply voltage, V_{S1}, based on the input voltage, V₁, wherein V_{S1} serves as the power supply voltage to some of the circuitry included within the communications bridge system 200′, as illustrated in FIG. 12. In one embodiment, the power supply 234 is operable to produce V_{S1} at a nominal level of 5.0 volts based on an input voltage, V₁, which may range between nominal voltage levels of 12.0-42.0 volts, although it will be understood that the power supply circuit 234 may alternately be configured to produce V_{S1} at any desired voltage level based on any desired input voltage range. In the embodiment illustrated in FIG. 12, the power supply 234 further produces a second supply voltage, V_{S2}, also based on V₁, which serves as a lower power supply voltage to some of the remaining circuitry included within the communications bridge system 200′ as illustrated in FIG. 12. In one embodiment, V_{S2} is 3.3 volts, although other low voltage values are contemplated. Optionally, as shown in phantom in FIG. 12, the power supply 234 may further produce a programming voltage, V_{P}, that is supplied to DSP 224 as a programming voltage for programming flash memory 226, as illustrated in FIG. 12. In one embodiment, V_{P} is 12.0 volts, although other low voltage values are contemplated.

System 200′ may also optionally include a conventional external battery charger circuit 236 receiving a charging voltage, V_{C}, from the power supply 234 and providing the charging voltage, V_{C}, to an external device port, EDP. In one embodiment, the external battery charger circuit 236 includes a resettable fuse or circuit breaker 238 operable to prevent damage to the power supply 234 resulting from external fault conditions. The battery charger circuit 236 may include an enable input, E, connected to an enable battery charger output, EBC, of the DSP 224, and the DSP 224 is operable in this embodiment to enable and disable operation of the external battery charger circuit 236 via the EBC output. The power supply 234 and battery charger circuit 236 may be configured to provide a charging voltage, V_{C}, suitable for charging one or more external batteries, such as those that may be associated with the remote system or unit 225. In one embodiment of system 200′, for example, the power supply 234 and battery charger circuit 236 are configured to provide a charging voltage, V_{C}, suitable for charging one or more batteries associated with a handheld PDA.

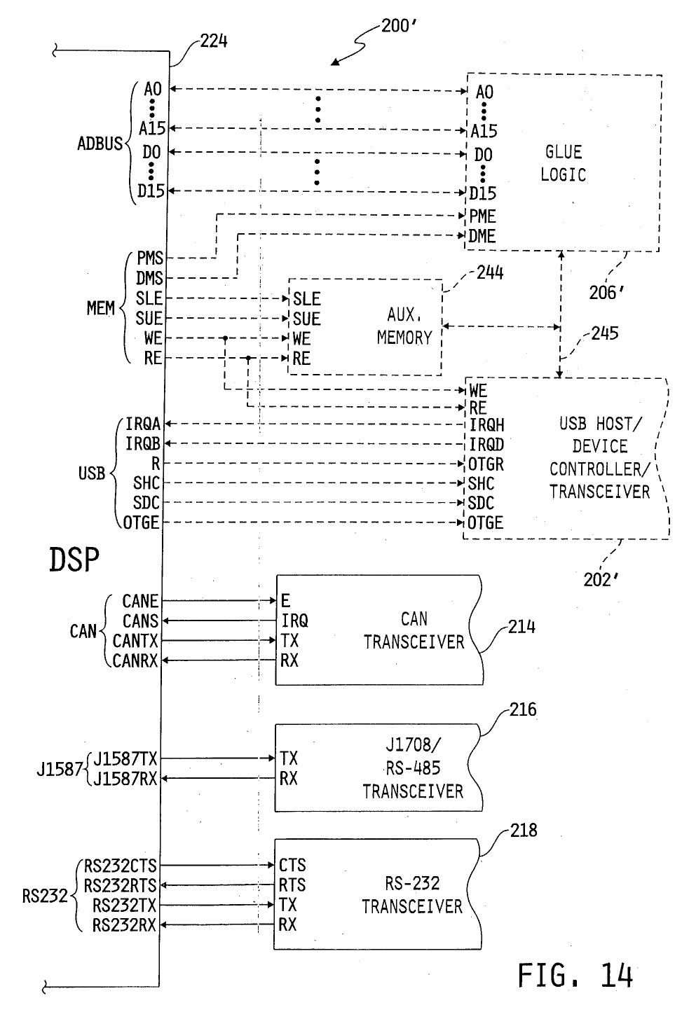

In the embodiment illustrated in FIG. 12, DSP 224 includes a serial communications interface (SCI) having an input/output port labeled RS232 that is operatively connected to an RS-232 transceiver 218. The RS-232 transceiver 218 is configured to serve as a communications interface between the DSP 224 and the remote system or unit 225, and is accordingly configured for electrical connection to an RS-232 communications port of the remote system or unit 225 via a correspondingly configured one of the signal paths 215₁-215_{M}. Thus connected, DSP 224 is operable to communicate with one or more remote systems or units 225 via the RS-232 communications protocol. It is to be understood that the RS-232 transceiver may alternatively be omitted in favor of another communications arrangement established between DSP 224 and the remote system or unit 225; e.g., a parallel communications connection, USB connection, wireless communications connection, or the like, or alternatively still be included in any such system as an additional or optional communication interface between DSP 224 and the remote system or unit 225. In any case, the RS-232 transceiver 218 is identical to the conventional transceiver 218 described hereinabove with respect to FIG. 2 in that it includes a data receiving input, RXD, and a data transmission output, TXD. Additionally, transceiver 218 includes a conventional “ready to send” input, RTS, and a conventional “clear to send” output, CTS, the purposes of which will be described hereinafter with respect to FIG. 14. The TXD and CTS outputs, as well as the RXD and RTS inputs and a ground connection, of transceiver 218 are shown electrically connected to a first connector C1 in FIG. 12, wherein C1 may be any known electrical connector. In one exemplary embodiment, C1 is a conventional female 9-pin D-subminiature connector having the pin assignments illustrated in Table 1.

TABLE 1

| C1 Connector Pin Number | RS-232 Transceiver Connection |
|---|---|
| 2 | RXD |
| 3 | TXD |
| 5 | Ground |
| 7 | RTS |
| 8 | CTS |

DSP 224 further includes another serial communications interface (SCI) having an input/output port labeled J1587 that is operatively connected to a J1708/RS-485 transceiver 216, wherein the J1708/RS-485 transceiver 216 is configured to serve as a communications interface between DSP 224 and the SAE J1708 vehicle communications network 108, illustrated in FIG. 11. The J1708/RS-485 transceiver 216 is identical to the conventional J1587 transceiver 216 described hereinabove with respect to FIG. 2 and includes data input/output ports J1708+ and J1708− configured for connection to the J1708 vehicle communications network 108₁. Thus connected, DSP 224 is operable to communicate with one or more control computers in communication with the J1708 vehicle communications network via the SAE J1587 communication protocal. The J1708+ and J1708− ports of transceiver 216 are shown electrically connected to a second connector C2 in FIG. 12, wherein C2 may be any known electrical connector.

DSP 224 further includes a controller area network (CAN) controller having an input/output labeled CAN that is operatively connected to a CAN transceiver 214, wherein the CAN transceiver 214 is configured to serve as a communications interface between DSP 224 and the SAE J1939 vehicle communications network 108_{N} illustrated in FIG. 11. The CAN transceiver 214 is identical to the conventional CAN transceiver 214 described hereinabove with respect to FIG. 2 and includes data input/output ports J1939+ and J1939−, as well as a shield connection, J1939S, configured for connection to the J1939 vehicle communications network 108_{N}. Thus connected, DSP 224 is operable to communicate with one or more control computers in communication with the J1939 vehicle communications network via the SAE J1939 communications protocol. The J1939+, J1939− and J1939S ports of transceiver 214 are shown electrically connected to connector C2 in FIG. 12, wherein C2 may be any known electrical connector. In one exemplary embodiment, C2 is a conventional male 25-pin D-subminiature connector having the pin assignments illustrated in Table 2.

TABLE 2

| | J1708/RS-485 and CAN Transceiver |
|---|---|
| C2 Connector Pin Number | Connections |
| 3 | J1708+ |
| 4 | J1708− |
| 6 | J1939+ |
| 7 | J1939S |
| 8 | J1939− |
| 23 | Ground |
| 25 | V_{E} |

It is to be understood that although the J1708/RS-485 transceiver 216 and CAN transceiver 214 are illustrated in FIG. 12 as both being connected to a single connector, C2, each transceiver may alternatively be connected to its own dedicated connector configured for connection to a corresponding one of the vehicle communication networks 108₁-108_{N}.

In the embodiment illustrated in FIG. 12, the communications bridge system 200′ is shown as optionally including a USB host/device controller/transceiver 202′ and/or an additional auxiliary memory unit 244 coupled to an address and data bus port, ADBUS, via a glue logic circuit 206′. It is to be understood that USB controller/transceiver 202′ may be included as the sole communications interface between DSP 224 and the remote system or unit 225, in which case the RS-232 transceiver 218 may be omitted, or may alternative be included in addition to the RS-232 transceiver 218, in which case communication with one or more remote systems or units 225 may be conducted either separately or simultaneously via the RS-232 transceiver 218 and/or USB controller/transceiver 202′.

The USB host/device controller transceiver 202′ is identical in many respects to the USB controller 202 illustrated and described with respect to FIG. 2, with the exception that the USB controller/transceiver 202′ includes only a single communications port that may be configured, in a known manner, as a host port, a device port or an on-the-go host or device port. It is to be understood, however, that the USB controller/transceiver 202′ may alternatively include any number of desired communication ports. For example, the USB controller/transceiver 202′ illustrated in FIG. 12 may alternatively be implemented as the USB controller 202 illustrated in FIG. 2.

In any case, DSP 224 includes an address and data bus port with the necessary control signals, ADBUS, that is operatively connected to the USB controller/transceiver 224 via the glue logic circuit 206′, which may be identical to the interface logic circuit 206 illustrated and described with respect to FIG. 2 as this circuit 206 relates to the interface between DSP 224 and the USB controller/transceiver 202′. In embodiments of system 200′ including the USB controller/transceiver 202′, it is configured to serve as a communications interface between the DSP 224 and the remote system or unit 225, and is accordingly configured for electrical connection to a corresponding USB communications port of the remote system or unit 225 via a correspondingly configured one of the signal paths 215₁-215_{M}. Thus connected, DSP 224 is operable to communicate with one or more remote systems or units 225 via the USB communications protocol. In the embodiment illustrated in FIG. 12, the USB controller/transceiver 202′ includes a number of additional inputs and outputs coupled to a USB control port, USB, of DSP 224, through which DSP 224 may control certain port configuration and data transfer functions typically associated with the operation of the embodiment of the USB controller/transceiver 202′ illustrated in FIG. 12. The USB control port, USB, of DSP 224 will be described more fully hereinafter with respect to FIG. 14.

In some embodiments of system 200′, the USB controller/transceiver 202′ may require a clock source having a clock frequency different from, and/or not readily derivable from, that provided by crystal/oscillator circuit 208. In such embodiments, system 200′ includes a second crystal/oscillator circuit 246, of conventional construction, providing a second clock signal to a clock input, XTAL, of the USB controller/transceiver 202′. In one embodiment, for example, the second crystal/oscillator circuit 246 is configured to supply a 12 MHz clock signal to the XTAL input of the USB controller/transceiver 202′, although it will be understood that the second crystal/oscillator circuit 246 may alternatively be configured to supply the USB controller/transceiver 202′ with a clock signal of any desired frequency.

The VBUS, D+, D−, ID and ground connections to the USB controller/transceiver 202′ are shown electrically connected to a third connector C3 in FIG. 12, wherein C3 may be any known electrical connector. In one exemplary embodiment, C3 is a conventional Mini-AB connector having the pin assignments illustrated in Table 3.

TABLE 3

| | USB Controller/ |
|---|---|
| C3 Connector Pin Number | Transceiver Connection |
| 1 | VBUS |
| 2 | D− |
| 3 | D+ |
| 4 | ID |
| 5 | Ground |
| Shell | Shield |

In the embodiment illustrated in FIG. 12, the communications bridge system 200′ is shown as optionally including an additional auxiliary memory unit 244 coupled to the address and data bus port, ADBUS, via the glue logic circuit 206′. The auxiliary memory unit 244 may comprise a conventional static or dynamic memory circuit of any desired size, that may be used to supplement the program and/or data memory capacity of DSP 224. In one exemplary embodiment of system 200′, the auxiliary memory unit 244 is implemented as a 32K word-size SRAM. In embodiments of system 200′ including auxiliary memory unit 244, the glue logic circuit 206′ includes conventional logic circuitry necessary to provide appropriate chip select and like functions typically associated with the operation of memory circuitry, and such conventional circuitry comprising part of the glue logic circuit 206′ will be generally known to a skilled artisan. In the embodiment illustrated in FIG. 12, the auxiliary memory unit 244 includes a number of additional inputs coupled to a memory port, MEM, of DSP 224, through which DSP 224 may control certain read/write enable/disable and memory byte selection functions typically associated with the operation of memory circuitry and/or USB controller circuitry. The memory port, MEM, of DSP 224 will be described more fully hereinafter with respect to FIG. 14.

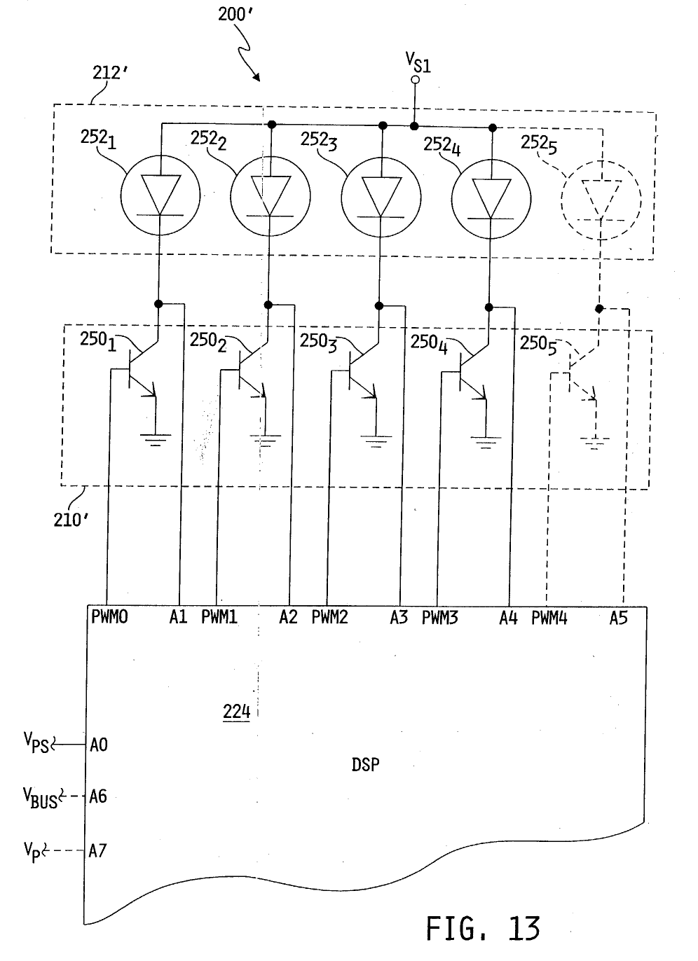

System 200′ further includes an indicator circuit 212′ and associated indicator driver circuit 210′ controlled by an I/O port of DSP 224 as illustrated in FIG. 12. Indicator circuit 212′ may generally include any number of visual indicators operatively coupled to, and controlled by, a conventional driver circuit 210′, which is controlled by DSP 224. One embodiment of circuits 212′ and 210′ may accordingly be implemented using the LED and LED driver circuits 212 and 210 respectively illustrated and described hereinabove with respect to FIG. 2, although other implementations of circuits 210′ and 212′ are contemplated. DSP 224 also includes an analog-to-digital voltage monitoring port, ADC, operable to monitor the operating voltages of the one or more indicator drivers comprising circuit 210′, and also operable to monitor other operating voltages associated with system 200′ as will be described more fully hereinafter with respect to FIG. 13.

Referring now to FIG. 13, a diagrammatic illustration of a portion of the communications bridge system 200′ is shown illustrating one embodiment of the indicator circuit 212′, indicator driver circuit 210′ and supply/operating voltage monitoring arrangement. The indicator driver circuit 210′ is shown as including four, and optionally five, drive transistors 250₁-250₅, each having a base connected to a corresponding one of a pulse-width modulated output, PWM0-PWM5, of DSP 224, an emitter connected to ground, and a collector connected to the cathode of a corresponding one of five LEDs, 252₁-252₅, comprising the indicator circuit 212′. The anodes of the LEDs, 252₁-252₅, are all connected to the supply voltage, V_{S1}. In the illustrated embodiment, the drive transistors are bipolar NPN transistors, although other conventional drive transistors may alternatively be used. Examples of such other drive transistors include, but are not limited to, metal-oxide-semiconductor (MOS) transistors, insulated gate bipolar transistors (IGBTs), field effect transistors (FETs), or the like. Those skilled in the art will recognize that the embodiment shown in FIG. 13 is provided only by way of illustration, and that conventional passive supporting components, such as capacitors and resistors, are not shown for simplicity, and that other known driver/indicator configurations and devices may be substituted therefor without detracting from the scope of the invention. For example, other controllable indicators may be used in place of LEDs, wherein examples include, but are not limited to, lamps, liquid crystal displays, vacuum fluorescent displays, cathode ray tube displays, or the like. As another example, while the indicator driver circuit 210′ is illustrated as implemented in a low-side driver configuration, circuit 210′ may alternatively be implemented in a high-side driver configuration, in which case the supply voltage, V_{S1}, will be connected to circuit 210′ as illustrated in phantom in FIG. 12, or alternatively still circuit 210′ may be implemented in a known bridge configuration of two or more transistors.

In the illustrated embodiment, the collectors of the drive transistors 250₁-250₅ are each connected to a corresponding analog-to-digital input, A1-A5, of DSP 224, and DSP 224 is operable to monitor the collector voltages of the drive transistors 250₁-250₅ to thereby monitor the on/off and/or fault status of each of the LEDs 252₁-252₅. DSP 224 includes three additional analog-to-digital inputs, A0, A6 and A7, receiving voltages V_{PS}, V_{BUS} and V_{P} respectively, wherein V_{PS} may correspond to V_{E}, V_{A1} or V_{S2} illustrated in FIG. 12. Alternatively or additionally, either or both of the battery voltage, V_{B}, and the charge voltage, V_{C}, may be monitored by DSP 224 as shown in phantom in FIG. 12. Although not specifically illustrated in the drawings, one or more other operating voltages associated with system 200′ may alternatively or additionally be monitored by DSP 224.

LEDs 252₁-252₅ are included to provide an indication of the operational status of the external voltage, V_{E}, as well as an indication of the operational status of each of the communication interfaces. In one embodiment, for example, LED 252₁ is the status indicator for V_{E}, LED 252₂ is the status indicator for the J1708/RS-485 communications interface 216 to DSP 224 (connectable to the SAE J1708 vehicle communications network), LED 252₃ is the status indicator for the CAN communications interface to 214 DSP 224 (connectable to the SAE J1939 vehicle communications network), LED 252₄ is the status indicator for the RS-232 communications interface 218 to DSP 224 (connectable to the RS-232 communications port of a remote system or unit 225), and LED 252₅ is an optional status indicator for the optional USB interface 202′ to DSP 224 (connectable to the USB communications port of a remote system or unit 225).

The DSP 224 is configured to control the indicators 252₁-252₅ in a manner that provides an indication of the operational status of the external voltage, V_{E}, and of the various communication interfaces, as well as an indication of any fault/failure conditions associated therewith. In one embodiment, for example, DSP 224 is responsive to the external source voltage, V_{E}, at input A0 to maintain LED 252₁ in an “on” condition when V_{E} is within an acceptable voltage range, to maintain LED 252₁ in an “off” condition when V_{E} is below a threshold voltage that is less than the acceptable range (e.g., near ground potential), and to periodically activate LED 252₁ at a predefined rate (e.g., 1 Hz) when V_{E} is outside of the acceptable range, but above the threshold voltage. With regard to the indicators 252₂-252₅, the DSP 224 is operable to provide an indication of operating and fault/failure conditions associated with each of the communications interfaces 214, 216, 218 and 202′ respectively by periodically activating a corresponding one of the LEDs 252₂-252₅ at a first predefined rate (e.g., 1 Hz) when the respective communications interface 214, 216, 218 and 202′ is detected as not being responded to by a corresponding one of the vehicle communication networks or remote system, by periodically activating a corresponding one of the LEDs 252₂-252₅ at a second predefined rate (e.g., 10 Hz) when the respective communications interface 214, 216, 218 and 202′ is detected as being responded to by a corresponding one of the vehicle communication networks or remote system and is transmitting and receiving data, and by maintaining a corresponding one of the LEDs 252₂-252₅ in an “off” state when the respective communications interface 214, 216, 218 and 202′ is not transmitting or receiving data. Other indicator control strategies will occur to those skilled in the art, and any such other indicator control strategies are intended to fall within the scope of the claims appended hereto.

Referring now to FIG. 14, a diagrammatic illustration of another portion of the communications bridge of FIG. 12 is shown illustrating one embodiment of the input/output connections between the DSP 224 and the various communications transceivers 214, 216, 218 and 202′. In the illustrated embodiment, the RS232 port of DSP 224 includes a data receiving input, RS232RX, for receiving data from a data receiver output, RX, of the RS-232 transceiver 218, and a data transmission output, RS232TX, for transmitting data to a data transmission input, TX, of the RS-232 transceiver 218. The RS232 port of DSP 224 further includes a clear-to-send output, RS232CTS, connected to a clear-to-send input, CTS, of the RS-232 transceiver 218, and a ready-to-send input, RS232RTS, connected to a ready-to-send output, RTS, of the RS-232 transceiver.

In operation, when DSP 224 has data to send to a remote system or unit 225 via the RS232 port, it sends the data to the TX input of the RS-232 transceiver 218 via its RS232TX output. The RS-232 transceiver then sends the data received from DSP 224, configured according to the RS-232 communications protocol, to an RS-232 port of the remote systems or unit 225 connected to its data receiver input, RXD, via one of the signal paths 215₁-215_{M}. When the remote system or unit 225 has data to send to DSP 224, it sends an appropriate signal to the ready-to-send input, RS232RTS, of the DSP 224 via the ready-to-send feature of the RS-232 transceiver 218, signaling to the DSP 224 that the remote system or unit 225 is ready to send RS-232 data. The DSP 224, in turn, signals when it's ready to receive the data by sending an appropriate signal to its clear-to-send output, CTS. The CTS feature of the RS-232 transceiver 218 then sends the CTS signal to the remote system or unit 225, and the remote system or unit 225 acknowledges the CTS signal and subsequently sends the data, configured according to the RS-232 communications protocol, to the receiving input, RXD, of the RS-232 transceiver 218. The RS-232 transceiver 218 then transmits the data to the RS232RTS input of the DSP 224 via its data transmission output RX.

In the embodiment illustrated in FIG. 14, the J1587 port of DSP 224 includes a data receiving input, J1587RX, for receiving data from a data receiver output, RX, of the J1708/RS-485 transceiver 216, and a data transmission output, J1587TX, for transmitting data to a data transmitting input, TX, of the J1708/RS-485 transceiver 216. In operation, when DSP 224 has data to send to one or more of the control computers coupled to the SAE J1708 vehicle communication network 108₁, it sends the data to the TX input of the J1708/RS-485 transceiver 216 via the J1587TX output. The J1708/RS-485 transceiver then sends the data received from DSP 224, configured according to the SAE J1587 communications protocol, to the J1708 vehicle communications network 108₁ via the J1708+ and J1708− I/Os for receipt by the one or more control computers coupled thereto. When one or more of the control computers coupled to the SAE J1708 vehicle communications network have data to send to the DSP 224, it sends the data, configured according to the SAE J1587 communications protocol, to the J1708+ and J1708− I/Os of the J1708/RS-485 transceiver 216 via the J1708 vehicle communications network 108₁ coupled thereto. The J1708/RS-485 transceiver 216, in turn, transmits the data received from the one or more control computers to the data receiving input, J1587RX, of the DSP 224 via the data receiving output, RX, of the J1708/RS-485 transceiver 216.

In the embodiment illustrated in FIG. 14, the CAN port of DSP 224 includes a data receiving input, CANRX, for receiving data from a data receiving output, RX, of the CAN transceiver 214, and a data transmission output, CANTX, for transmitting data to a data transmission input, TX, of the CAN transceiver 216. Additionally, the CAN port of DSP 224 includes a CAN enable output, CANE, connected to an enable input, E, of the CAN transceiver 214, and a CAN standby input, CANS, connected to an interrupt output, IRQ, of the CAN transceiver 216.

In operation, when DSP 224 is ready to receive data from or has data to send to one or more of the control computers coupled to the SAE J1939 vehicle communication network 108_{N}, it first monitors its standby input, CANS, and if the state of the interrupt signal produced by the CAN transceiver 214 at its interrupt output, IRQ, indicates that the transceiver 214 is ready to be taken out of standby mode, the DSP 224 produces a signal at its enable output, CANE, that takes the CAN transceiver 214 out of standby mode. The DSP 224 then sends the data to the TX input of the CAN transceiver 214 via the CANTX output. The CAN transceiver 214 then sends the data received from DSP 224, configured according to the SAE J1939 communications protocol, to the J1939 vehicle communications network 108_{N} via the J1939+ and J1939− I/Os for receipt by the one or more control computers coupled thereto. When one or more of the control computers coupled to the SAE J1939 vehicle communications network have data to send to the DSP 224, it sends the data, configured according to the SAE J1939 communications protocol, to the J1939+ and J1939− I/Os of the CAN transceiver 214 via the J1939 vehicle communications network 108_{N} coupled thereto. The CAN transceiver 214 then transmits the data received from the one or more control computers to the data receiving input, CANRX, of the DSP 224 via the data receiving output, RX, of the CAN transceiver 214.

In the communications bridge system 200′ illustrated and described with respect to FIG. 12, the auxiliary memory 244 and/or USB controller/transceiver 202′ were indicated as optional in that embodiment, and these devices, as well as the supporting circuitry and interface of these components with DSP 224 in FIG. 14 are accordingly shown in phantom. In the embodiment illustrated in FIG. 14, the address and data bus port, ADBUS, of the DSP 224 comprises 16 address I/Os and 16 data I/Os, A0-A15 and D₀-D15 respectively, which are connected to corresponding address and data I/Os, A₀-A₁₅ and D₀-D₁₅, of the glue logic circuit 206′. Program memory select (PMS) and data memory select (DMS) outputs of the MEM port are also connected to corresponding program memory enable (PME) and data memory enable (DME) inputs of the glue logic circuit 206′. The DSP 224 is operable to interface with either of the USB controller/transceiver 202′ and the auxiliary memory unit 244 via these address, data and control lines to transport and control the flow of data thereto and therefrom as described hereinabove.

As described hereinabove with respect to FIG. 12, DSP 224 includes an output port, MEM, for providing the auxiliary memory 244 with read/write enable/disable and memory byte selection signals. For example, the MEM port of DSP 224 includes a write enable output, WE, and a read enable output, RE, connected to corresponding write enable, WE, and read enable, RE, inputs of the auxiliary memory unit 244 and of the USB controller/transceiver 202′. Via appropriate signals produced at the WE and RE outputs, DSP 224 is operable to selectively enable the auxiliary memory unit 244 and/or the USB controller/transceiver 202′ for writing data thereto and reading data therefrom. Finally, in embodiments wherein the auxiliary memory unit 244 is provided as SRAM, the MEM port of DSP 224 includes an SRAM lower-byte access enable output, SLE, and an SRAM upper-byte access enable output, SUE, connected to corresponding SLE and SUE inputs of the auxiliary memory unit 244. Via appropriate signals produced at the SLE and SUE outputs, DSP 224 is operable to selectively enable access to lower and upper bytes of SRAM memory.

Also as described hereinabove with respect to FIG. 12, DSP 224 includes a USB control port, USB, for controlling certain port configuration and data transfer functions associated with the USB controller/transceiver 202′. For example, the USB control port of DSP 224 includes first and second interrupt inputs, IRQA and IRQB, connected to corresponding host and device interrupt outputs, IRQH and IRQD, of the USB controller/transceiver 202′. DSP 224 also controls data flow between itself and USB controller/transceiver 202′ through the read and write enable outputs, RE and WE respectively of the MEM port as described hereinabove. The USB control port of DSP 224 further includes a reset output, R, and an on-the-go enable output, OTGE, connected to corresponding on-the-go reset and on-the-go enable inputs, OTGR and OTGE respectively, of the USB controller/transceiver 202′. Finally, the USB control port of DSP 224 includes suspend host control, SHC, and suspend device control, SDC, outputs connected to corresponding SHC and SDC inputs of the USB controller/transceiver 202′.

Communications between DSP 224 and a remote system or unit 225 via the USB controller/transceiver 202′ may be conducted with the USB controller/transceiver acting either as a USB host or USB device, with its USB communication port configured as a standard USB host port, a standard USB device port, or as an on-the-go USB port with both host and device capabilities. The USB control port of the DSP 224 and corresponding I/Os of the USB controller/transceiver 202′ control, in a similar manner to the CAN controller described hereinabove, the timing of data transfer between DSP 224 and the remote system or unit 225, whereas the actual data transferred between DSP 224 and the USB controller transceiver 202′ is conducted via the address and data bus port, ADBUS, and the one or more signal paths 245 coupling the USB controller/transceiver 202′ to the glue logic circuit 206′.

In operation, when DSP 224 has data to send to a remote system or unit 225 via one of the signal paths 215₁-215_{M}, it first configures the USB controller/transceiver 202′ appropriately through address/data bus (ADBUS) write transactions, and then monitors its interrupt inputs IRQA and IRQB for events involving USB controller/transceiver data communications activities. If the USB controller/transceiver 202′ is configured as a host, and if the USB communications port of the USB controller/transceiver 202′ is to be configured as a standard USB host port, then when the state of the interrupt signal produced by the IRQH output of the USB controller/transceiver 202′ indicates that the USB controller/transceiver 202′ is ready to send data or status information relating to communications events to DSP 224, DSP 224 produces appropriate address/data bus (ADBUS) and control signals to capture the information. The DSP 224 produces appropriate signals at its SHC, SDC and OTGE outputs to suspend operation of the USB device controller, to deactivate the OTG controller and maintain it in a disabled state, and to enable operation of the USB host controller. When DSP 224 undergoes a reset condition, such as that caused by a drop in supply voltage or a watchdog timeout event, its reset output signal, R, becomes active and resets the USB controller/transceiver 202′ back to its preconfigured state. If, however, the USB communications port of the USB controller/transceiver 202′ is to be configured as an on-the-go port, DSP 224 instead produces appropriate signals at its SHC, SDC and OTGE outputs to suspend operation of the USB host and device controllers, and to enable operation of the USB on-the-go controller as a host port.

On the other hand, if the USB controller/transceiver 202′ is configured as a device, and if the USB communications port of the USB controller/transceiver 202′ is to be configured as a standard USB device port, then when the state of the interrupt signal produced by the IRQD output of the USB controller/transceiver 202′ indicates that the USB controller/transceiver 202′ is ready to send data or status information relating to communications events to DSP 224, DSP 224 produces appropriate address/data bus (ADBUS) and control signals to capture the information. DSP 224 produces appropriate signals at its SHC, SDC and OTGE outputs to suspend operation of the USB host controller, to deactivate the OTG controller and maintain it in a disabled state, and to enable operation of the USB device controller. When DSP 224 undergoes a reset condition, such as that caused by a drop in supply voltage or a watchdog timeout event, its reset output signal, R, becomes active and resets the USB controller/transceiver 202′ back to its preconfigured state. If, however, the USB communications port of the USB controller/transceiver 202′ is to be configured as an on-the-go port, DSP 224 instead produces appropriate signals at its SHC, SDC and OTGE outputs to suspend operation of the USB host and device controllers, and to enable operation of the USB on-the-go controller as a device port.

Once the remote system or unit 225 has signaled to DSP 224 via the USB controller/transceiver 202′ that it is ready to receive data, and the USB controller/transceiver 202′ is properly configured as just described, DSP 224 sends the actual data through the glue logic circuit 206′ to the USB controller/transceiver 202′ via the address and data bus port, ADBUS, and the one or more signal paths 245, along with the necessary write and select control signals. Thereafter, the USB controller/transceiver 202′ sends the data received from DSP 224, configured according to the USB communications protocol, to the USB port of the remote system or unit 225 via the D+ and D− I/Os connected to one of the signal paths 215₁-215_{M} connected thereto.

When a remote system or unit 225 has data to send to DSP 224 via one of the signal paths 215₁-215_{M}, it sends the data, configured according to the USB communications protocol, to the D+ and D− I/Os of the USB controller/transceiver 202′ via one of the signal paths 215₁-215_{M} connected thereto. After another USB controller/transceiver interrupt sequence as just described, the USB controller/transceiver 224 then transmits the data received from the remote system or unit 225 to DSP 224 through the glue logic circuit 206′ via the one or more signal paths 245 and the address and data bus port, ADBUS, along with the necessary read and select control signals.

In one embodiment, the communications bridge system 200′ illustrated and described herein thus far with respect to FIGS. 11-14 is further configured for automatic resetting when the DSP 224 no longer is executing coded instructions properly and power savings upon detection of periods of inactivity. In this embodiment, for example, DSP 224 is configured to include an Operating Properly (OP) watchdog timer function operable to reset the DSP 224, such that the DSP 224 executes a reset sequence whenever a watchdog timer within the DSP 224 is not properly written to before a predefined time-out period e.g., 200 ms). The watchdog timer is enabled while the DSP 224 is in wait mode.

If there are no RS-232 or USB communications detected for a predefined time period, e.g., 30 seconds, the DSP 224 is operable to enter the wait mode. The DSP 224 remains in the wait mode until either a USB or RS-232 communications received interrupt is asserted. After there are no USB communications detected for a predefined time period, e.g., 30 seconds, the USB OTG controller is placed into power saving mode where it remains until new USB communications are detected or a USB controller register is accessed. Similarly, after there are no RS-232 communications detected for a predefined time period, e.g., 30 seconds, the DSP 224 is operable to place the RS-232 transceiver 218 into an inoperative stop mode, where it remains until an RS-232 communications received interrupt is asserted. Likewise, after there are no J1708 communications detected for a predefined time period, e.g., 30 seconds, the DSP 224 is operable to place the J1587 port into an inoperative stop mode, where it remains until a J1708 communications received interrupt is asserted. Additionally, after there are no J1939 communications detected for a predefine time period, e.g., 30 seconds, the DSP 224 is operable to place its CAN controller circuitry in a power down stop mode until new communications are received.

The transmitting outputs of both the CAN transceiver 214 and J1708/RS-485 transceiver 216 remain in a recessive state while they are not communicating. With the DSP in a normal operating mode, both the CAN transceiver 214 and the CAN controller circuit of the DSP 224 will be activated to a normal/run mode when J1939 communications are detected by the CAN transceiver 214.

If the low voltage supply, V_{S2}, drops below a threshold voltage, e.g., 2.7 volts with V_{S2}=3.3 volts nominally, a low-voltage interrupt will be asserted internal to the DSP 224 so that the DSP 224 will prepare for shutdown.

The communications bridge system 200′ just described is fully compliant with the RP-1210A PC to data link interface trucking standard; i.e., for the CAN/J1939, J1708/J1587, RS-232 and USB communication interfaces. It is capable of communicating with multiple control computers carried by the motor vehicle 100 over any one or more of the vehicle communication networks 108₁-108_{N}. It is also capable of conducting communications between any one or more of the control computers carried by the motor vehicle 100 and a remote system or unit 225 via a USB communications or RS-232 link with one or more other communications bridge systems 200′ that are simultaneously conducting communications between one or more other control computers carried by one or more other vehicles and the remote system.

The flash memory carried by DSP 224 is reprogrammable as a stand-alone function, and is reprogrammable external to the system 200′ through either of the RS-232 transceiver 218 or the USB controller/transceiver 202′ in embodiments of system 200′ that include the USB controller/transceiver 202′.

As described hereinabove, DSP 224 may be implemented with a DSP56F807 Digital Signal Processor. The DSP56F807 is available as a 160-pin packaged integrated circuit, and the following Table 4 sets forth one I/O configuration of the DSP56F807 as it relates to system 200′ shown and described hereinabove. Where appropriate, the I/O port or pin names of the DSP56F807 in Table 4 are related back parenthetically to their corresponding ports or I/Os illustrated and described with respect to FIGS. 12-14.

TABLE 4

| I/O Port Pin Name | I/O Port Pin Configuration |
|---|---|
| CLK0 | Configure as disabled clock output |
| A0-A5 | Configure as external address bus, with DRV register bit = |
| | 0 and weak internal pull-ups in circuit (ADBUS) |
| A6-A7 (GPIOE2- | Configure as external address bus, with DRV register bit = |
| GPIOE3) | 0; with no USB or external RAM, configure as unused |
| | digital inputs with weak internal pull-ups in circuit (ADBUS) |
| A8-A15 (GPIOA0- | Configure as external address bus, with DRV register bit = |
| GPIOA7) | 0; with no USB or external RAM, configure as unused |
| | digital inputs with weak internal pull-ups in circuit (ADBUS) |
| D0-D15 | Configure as external data bus with weak internal pull-ups |
| | in circuit (ADBUS) |
| _PS | Configure as external Program Memory Select output with |
| | weak internal pull-up in circuit (PMS) |
| _DS | Configure as external Data Memory Select output with |
| | weak internal pull-up in circuit (DMS) |
| _WR | Configure as external Write Enable output with weak |
| | internal pull-up in circuit (WE) |
| _RD | Configure as external Read Enable output with weak |
| | internal pull-up in circuit (RE) |
| _IRQA | External Active-Low, Level-Triggered Interrupt Request |
| | input from the USB Host Controller; with no USB, this |
| | input is unused (externally pulled up to +3.3 V in hardware) |
| | (IRQA) |
| _IRQB | External Active-Low, Level-Triggered Interrupt Request |
| | input from the USB Device Controller; with no USB, this |
| | input is unused (externally pulled up to +3.3 V in hardware) |
| | (IRQB) |
| _RSTO | Reset output to the USB OTG Controller (R) |
| _RESET | Reset input (externally pulled up to +3.3 V in hardware) |
| EXTBOOT | External Boot input (externally pulled down to digital |
| | ground in hardware) |
| GPIOB0 | Configure as digital output to make CAN transceiver active |
| | or inactive; with GPIOB0 = 0, CAN transceiver is active, |
| | while with GPIOB0 = 1, CAN transceiver is in standby |
| | mode (CANE) |
| GPIOB1 | Configure as digital output for CTS functionality for RS- |
| | 232 port; with CTS = 1, the Adapter signals that it is OK to |
| | send data (RS232CTS) |
| GPIOB2 | Configure as active-low, negative-edge-triggered interrupt |
| | input from CAN controller receive output, which indicates |
| | when to take the CAN transceiver out of standby mode (CANS) |
| GPIOB3 | Configure as digital output to make the 5 V PDA charging |
| | circuit active when output high (for PDA version only); for |
| | non-PDA versions, configure as unused digital input with |
| | weak internal pull-up in circuit (EBC) |
| GPIOB4-GPIOB7 | Configure as unused digital inputs with weak internal pull-ups in circuit |
| GPIOD0 | Configure as digital input for RTS functionality for RS-232 |
| | port; with RTS = 1, the remote computer signals to the |
| | Adapter that it is ready to send data (RS232RTS) |
| GPIOD1 | Configure as active-low digital output to control lower-byte |
| | access of external SRAM. With 16-bit external SRAM |
| | access desired, both this pin and GPIOD2 should remain |
| | in a logic low state all the time (SLE) |
| GPIOD2 | Configure as active-low digital output to control upper-byte |
| | access of external SRAM. With 16-bit external SRAM |
| | access desired, both this pin and GPIOD1 should remain |
| | in a logic low state all the time (SUE) |
| GPIOD3 | Configure as digital output for H_SUSPEND functionality |
| | for USB port; with H_SUSPEND = 1, the USB Host |
| | Controller is in suspend mode (for non-USB product, |
| | configure as unused digital input with weak internal pull-up |
| | in circuit) (SHC) |
| GPIOD4 | Configure as digital output for D_SUSPEND functionality |
| | for USB port; with D_SUSPEND = 1, the USB Device |
| | Controller is in suspend mode (for non-USB product, |
| | configure as unused digital input with weak internal pull-up |
| | in circuit) (SDC) |
| GPIOD5 | Configure as digital output for _OTGMODE functionality |
| | for USB port; with _OTGMODE = 0, USB port 1 is an On- |
| | The-Go port (for non-USB product, configure as unused |
| | digital input with weak internal pull-up in circuit) (OTGE) |
| PWMA0 | Configure as independent PWM output pin for Power-on |
| | LED driver; with PWMA0 = 1, the LED is turned on |
| | (PWM0) |
| PWMA1 | Configure as independent PWM output pin for J1708 LED |
| | driver; with PWMA1 = 1, the LED is turned on (PWM1) |
| PWMA2 | Configure as independent PWM output pin for CAN LED |
| | driver; with PWMA2 = 1, the LED is turned on (PWM2) |
| PWMA3 | Configure as independent PWM output pin for RS-232 |
| | LED driver; with PWMA3 = 1, the LED is turned on (PWM3) |
| PWMA4 | Configure as independent PWM output pin for USB LED |
| | driver; with PWMA4 = 1, the LED is turned on (unused for |
| | non-USB product) (PWM4) |
| PWMA5 | Unused PWM output |
| ISA0-ISA2 | Unused PWM Current Status inputs (externally pulled up |
| | to +3.3 V in hardware) |
| FAULTA0-FAULTA3 | Unused PWM Fault inputs (externally pulled down to |
| | digital ground in hardware) |
| PWMB0-PWMB5 | Unused PWM outputs |
| ISB0-ISB2 | Unused PWM Current Status inputs (externally pulled up |
| | to +3.3 V in hardware) |
| FAULTB0-FAULTB3 | Unused PWM Fault inputs (externally pulled down to |
| | digital ground in hardware) |
| MISO (GPIOE6) | Configure as unused digital input with weak internal pull- |
| | up in circuit |
| MOSI (GPIOE5) | Configure as unused digital input with weak internal pull- |
| | up in circuit |
| SCLK (GPIOE4) | Configure as unused digital input with weak internal pull- |
| | up in circuit |
| _SS (GPIOE7) | Configure as unused digital input with weak internal pull- |
| | up in circuit |
| PHASEA0 (TA0) | Configure as unused digital input (externally pulled up to |
| | +3.3 V in hardware) |
| PHASEB0 (TA1) | Configure as unused digital input (externally pulled up to |
| | +3.3 V in hardware) |
| INDEX0 (TA2) | Configure as unused digital input (externally pulled up to |
| | +3.3 V in hardware) |
| HOME0 (TA3) | Configure as unused digital input (externally pulled up to |
| | +3.3 V in hardware) |
| PHASEA1 (TB0) | Configure as unused digital input (externally pulled up to |
| | +3.3 V in hardware) |
| PHASEB1 (TB1) | Configure as unused digital input (externally pulled up to |
| | +3.3 V in hardware) |
| INDEX1 (TB2) | Configure as unused digital input (externally pulled up to |
| | +3.3 V in hardware) |
| HOME1 (TB3) | Configure as unused digital input (externally pulled up to |
| | +3.3 V in hardware) |
| TXD0 (GPIOE0) | Configure as SCI0 transmit output for RS-232 port |
| | (RS232TX) |
| RXD0 (GPIOE1) | Configure as SCI0 receive input for RS-232 port |
| | (RS232RX) |
| TXD1 (GPIOD6) | Configure as SCI1 transmit output for J1708 port |
| | (J1587TX) |
| RXD1 (GPIOD7) | Configure as SCI1 receive input for J1708 port (J1587RX) |
| MSCAN_RX | CAN controller receive input with internal pull-up in circuit |
| | (CANRX) |
| MSCAN_TX | CAN controller transmit output (externally pulled up to +5 V |
| | in hardware) (CANTX) |
| ANA0 | Analog A/D channel input for sequential power supply |
| | input voltage measurement (A0) |
| ANA1 | Analog A/D channel input for sequential Power-on LED |
| | feedback voltage measurement (A1) |
| ANA2 | Analog A/D channel input for sequential J1708 LED |
| | feedback voltage measurement (A2) |
| ANA3 | Analog A/D channel input for sequential CAN LED |
| | feedback voltage measurement (A3) |
| ANA4 | Analog A/D channel input for sequential RS-232 LED |
| | feedback voltage measurement (A4) |
| ANA5 | Analog A/D channel input for sequential USB LED |
| | feedback voltage measurement (unused for non-USB |
| | product) (A5) |
| ANA6 | Analog A/D channel input for sequential USB V_{BUS} input |
| | voltage measurement (unused for non-USB product) (A6) |
| ANA7 | Analog A/D channel input for reading the 5 V PDA charge |
| | voltage (for PDA version only) (A7) |
| ANB0-ANB7 | Analog A/D channel inputs (externally pulled down to |
| | analog ground in hardware) |
| TC0-TC1 | Configure as unused timer inputs with weak internal pull- |
| | ups in circuit |
| TD0-TD3 | Configure as unused timer inputs with weak internal pull- |
| | ups in circuit |
| TCK | Configure as unused test input with weak internal pull- |
| | down in circuit |
| TMS | Configure as unused test input with weak internal pull-up |
| | in circuit |
| TDI | Configure as unused test input with weak internal pull-up |
| | in circuit |
| TD0 | Unused test output |
| _TRST | Configure as unused test input (externally pulled down to |
| | ground in hardware) |
| _DE | Unused test output |

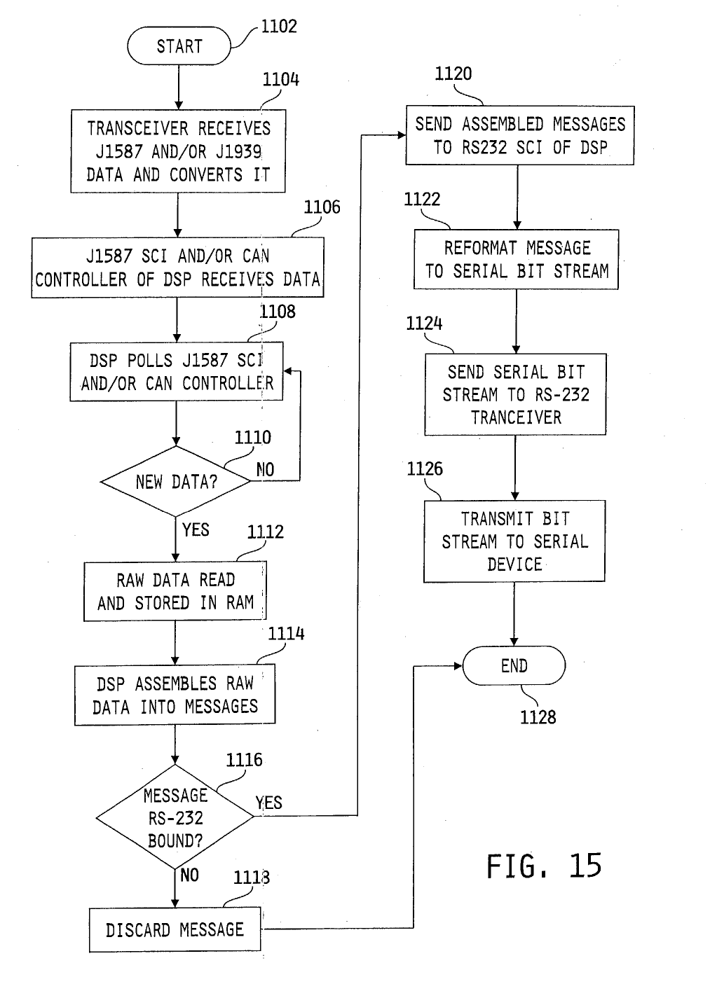

Referring now to FIG. 15, a flowchart is shown illustrating one embodiment of a process or algorithm for transferring information from either or both of the J1708 and J1939 vehicle communications networks (either independently or simultaneously) to a remote system or unit 225, configured for communication according to the RS-232 communications protocol, via the communications bridge system 200′ of FIGS. 11-14. The algorithm begins at step 1102, and at step 1104 serial information generated by one or more control computers carried by the vehicle 100 is received by the communications bridge system 200′ via either one or both of the two vehicle communication networks described hereinabove with respect to FIGS. 12-14. The first vehicle communications network is the SAE J1708 vehicle communications network 108₁, which is configured for communications according to the SAE J1587 communications protocol, and which is coupled to the J1708/RS-485 transceiver 216 via communications link 120₁. At step 1104, the received serial information may include serial information carried by vehicle communications network 108₁ and received at the J1708+ and J1708− I/Os of the J1708/RS-485 transceiver 216. The second vehicle communications network is the SAE J1939 vehicle communications network 108_{N}, which is configured for communications according to the SAE J1939 communications protocol, and which is coupled to the CAN transceiver 214 via communications link 120_{N}. At step 1104, the received serial information may include serial information carried by vehicle communications network 108_{N} and received at the J1939+ and J1939− I/Os of the CAN transceiver 214. In any case, the J1708/RS-485 transceiver 216 converts any serial data supplied thereto as required for processing by the serial communications interface (SCI), J1587, of DSP 224, and the CAN transceiver 214 converts any serial data supplied thereto as required for processing by the CAN controller interface, CAN, of DSP 224. Thereafter at step 1106, the converted serial data is respectively received by either or both of the J1587 SCI, and the CAN controller interface, CAN, of the DSP 224.

Following step 1106, the process advances to steps 1108-1110 where the DSP 224 polls the J1587 SCI and/or its CAN controller for new data in a continuous polling cycle. (The complete polling cycle includes polling all other interfaces, as well.) During each cycle, any new raw data is read and stored in a data memory at step 1112, which may be either associated with DSP 224, auxiliary memory unit 244 or other external memory. With regard to its CAN controller, DSP 224 may alternatively wait and respond as just described at step 1112 to an interrupt generated by the CAN controller in DSP 224 when data is received thereby. In any case, both polling software and interrupt handlers are well known in the art, and those skilled in the art will recognize that either method could be implemented without departing from the scope of the invention.

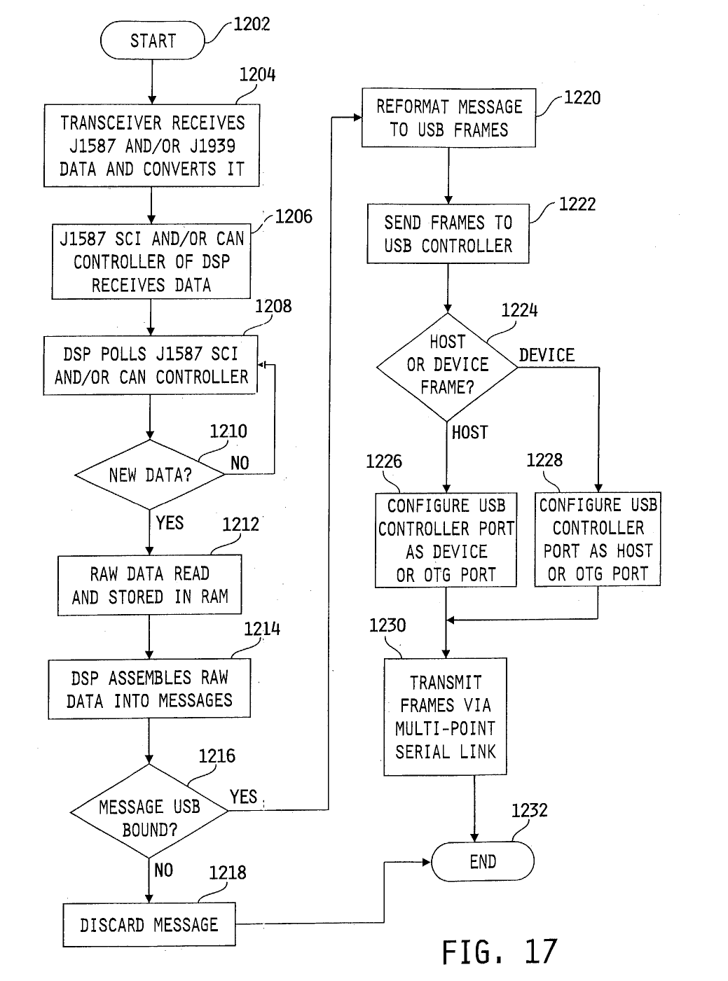

Thereafter at step 1114, DSP 224 assembles any raw data received from the J1708/RS-485 transceiver 216 and/or CAN transceiver 214 into messages, and at step 1116 DSP 224 determines whether any such messages are bound for transmission to a remote system or unit 225 via an RS-232 communications link. If not, such messages are discarded at step 1118. In embodiments of system 200′ that include USB controller/transceiver 202′, an additional decision step may be interposed between steps 1116 and 1118 wherein DSP 224 makes a determination of whether any of the messages not bound for RS-232 transmission are instead bound for transmission to a remote system or unit 225 via a USB communications link. If not, the process may then proceed to step 1118 where any such messages are discarded. If, however, any such messages are bound for USB transmission to a remote system or unit 225, the process may advance to a USB data transmission process, one illustrative embodiment of which will be described in greater detail hereinafter with respect to FIG. 17.

Following step 1116, the process advances to step 1120 where DSP 224 sends the assembled messages to its RS232 SCI. Thereafter at step 1122, the RS232 SCI reformats the assembled messages into a serial bit stream according to the RS-232 communications protocol. Thereafter at step 1124, DSP 224 sends the assembled and reformatted messages to the RS-232 transceiver 218 as described hereinabove with respect to FIG. 14, and following step 1124, the process advances to step 1126 where the RS-232 transceiver 218 transmits the assembled messages, reformatted according to the RS-232 communications protocol, to an RS-232 communications interface of the remote system or unit 225 coupled to the RS-232 transceiver 218 via an appropriate one of the communication paths 215₁-215_{M}. Following step 1126 or step 1118, the process ends at step 1128, and returns to the “start” step 1102.

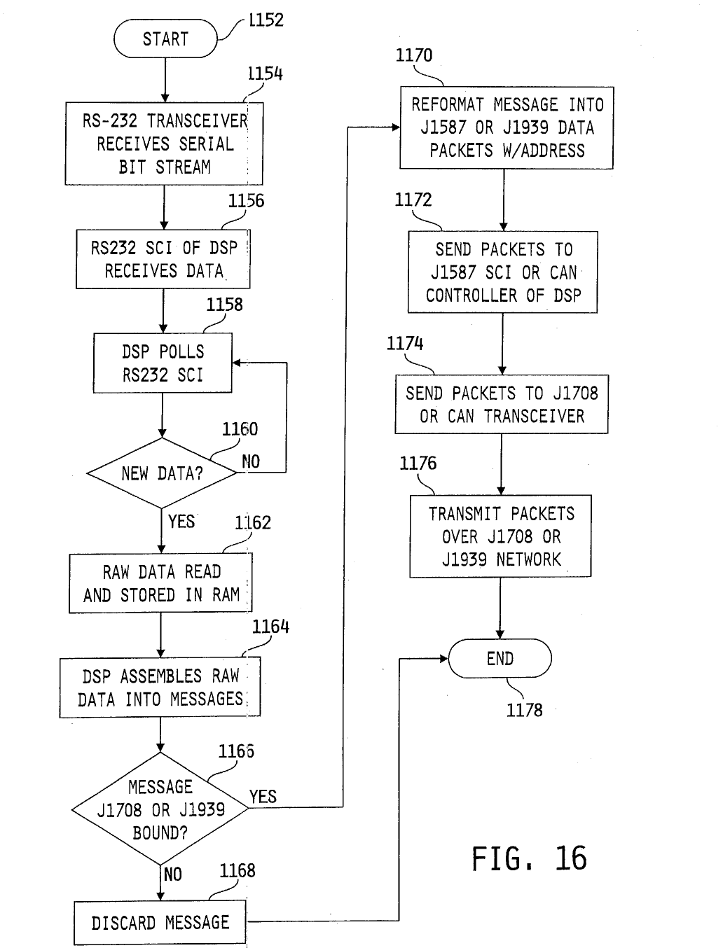

Referring now to FIG. 16, a flowchart is shown illustrating one embodiment of a process or algorithm for transferring information from the remote system or unit 225, configured for communication according to the RS-232 communications protocol, to either of the J1708 or J1939 vehicle communications networks via the communications bridge system 200′ of FIGS. 11-14. The process begins at step 1152, and at step 1154, serial information, transmitted by the remote system or unit 225 and configured according to the RS-232 communications protocol, is received by the RS-232 transceiver 218 coupled to the remote system or unit 225 via an appropriate one of the communication paths 215₁-215_{M}. Thereafter at step 1156, the RS-232 transceiver provides the serial information to the RS232 SCI of DSP 224. Following step 1156, the process proceeds to steps 1158-1160 where DSP 224 polls the RS232 SCI for new data in a continuous polling cycle. During each cycle, any new raw data is read and stored in a data memory at step 1162, which may be either associated with DSP 224, auxiliary memory unit 244 or other external memory. Alternatively, DSP 224 may wait and respond as just described at step 1162 to an interrupt generated by the RS-232 SCI in DSP 224 when data is received thereby. In any case, both polling software and interrupt handlers are well known in the art, and those skilled in the art will recognize that either method could be implemented without departing from the scope of the invention.

Thereafter at step 1164, DSP 224 assembles any raw data received from the RS-232 transceiver 218 into messages, and at step 1166 DSP 224 determines whether any of the messages are bound for transmission to either the J1708 vehicle communications network or the J1939 vehicle communications network. Any messages bound for neither vehicle communications network are discarded at step 1168. For any message bound for either the J1708 or J1939 vehicle communications network, DSP 224 is operable following step 1166 to reformat any such messages into appropriate data packets with addresses at step 1170. Messages bound for the J1708 vehicle communication network are reformatted by DSP 224 according to the SAE J1587 communications protocol, and any messages bound for the J1939 vehicle communications network are reformatted by DSP 224 according to the SAE J1939 communications protocol.

Following step 1170, the process advances to step 1172 where DSP 224 sends the reformatted data packets to an appropriate interface port. Those packets bound for the J1708 vehicle communications network are sent by DSP 224 to its J1587 SCI, and those packets bound for the J1939 vehicle communications network are sent by DSP 224 to its CAN controller. Thereafter at step 1174, DSP 224 sends the reformatted data packets to an appropriate transceiver for transmission to a corresponding one of the vehicle communication networks. Those packets bound for the J1708 vehicle communications network are sent by DSP 224 to the J1708/RS-485 transceiver 216, and those packets bound for the J1939 vehicle communications network are sent by DSP 224 to the CAN transceiver 214. Thereafter at step 1176, the transceivers 216 and/or 214 are operable to transmit the data provided to them by DSP 224 to one or more of the control computers carried by the vehicle 100 and coupled to either or both of the vehicle communications networks. For example, the J1708/RS-485 transceiver 216 is coupled to the J1708 vehicle communications link 108₁ via communications link 1201, and the J1708/RS-485 transceiver 216 is operable at step 1176 to transmit the data supplied thereto by DSP 224, which data is configured for communications according to the SAE J1587 communications protocol, to any one or more in-vehicle control computers coupled to the J1708 vehicle communications network 108₁. Likewise, the CAN transceiver 214 is coupled to the J1939 vehicle communications link 108_{N} via communications link 120_{N}, and the CAN transceiver 214 is operable at step 1176 to transmit the data supplied thereto by DSP 224, which data is configured for communications according to the SAE J1939 communications protocol, to any one or more in-vehicle control computers coupled to the J1939 vehicle communications network 108_{N}. The process advances from step 1176 or from step 1168 to step 1178 where the process ends, and then returns to the “start” step 1152.

Referring now to FIG. 17, a flowchart is shown illustrating one embodiment of a process or algorithm for transferring information from either or both of the J1708 and J1939 vehicle communications networks (either independently or simultaneously) to a remote system or unit 225, configured for communication according to the USB communications protocol, via the communications bridge system 200′ of FIGS. 11-14. The algorithm begins at step 1202, and at step 1204 serial information generated by one or more control computers carried by the vehicle 100 is received by the communications bridge system 200′ via either one or both of the two vehicle communication networks described hereinabove with respect to FIGS. 12-14. The first vehicle communications network is the SAE J1708 vehicle communications network 108₁, which is configured for communications according to the SAE J1587 communications protocol, and which is coupled to the J1708/RS-485 transceiver 216 via communications link 120₁. At step 1204, the received serial information may include serial information carried by vehicle communications network 108₁ and received at the J1708+ and J1708− I/Os of the J1708/RS-485 transceiver 216. The second vehicle communications network is the SAE J1939 vehicle communications network 108_{N}, which is configured for communications according to the SAE J1939 communications protocol, and which is coupled to the CAN transceiver 214 via communications link 120_{N}. At step 1204, the received serial information may include serial information carried by vehicle communications network 108_{N} and received at the J1939+ and J1939− I/Os of the CAN transceiver 214. In any case, the J1708/RS-485 transceiver 216 converts any serial data supplied thereto as required for processing by the serial communications interface (SCI), J1587, of DSP 224, and the CAN transceiver 214 converts any serial data supplied thereto as required for processing by the CAN controller interface, CAN, of DSP 224. Thereafter at step 1206, the converted serial data is respectively received by either or both of the J1587 SCI, and the CAN controller interface, CAN, of the DSP 224.

Following step 1206, the process advances to steps 1208-1210 where the DSP 224 polls the J1587 SCI and/or its CAN controller for new data in a continuous polling cycle. (The complete polling cycle includes polling all other interfaces, as well.) During each cycle, any new raw data is read and stored in a data memory at step 1212, which may be either associated with DSP 224, auxiliary memory unit 244 or other external memory. With regard to its CAN controller, DSP 224 may alternatively wait and respond as just described at step 1212 to an interrupt generated by the CAN controller within DSP 224 when data is received thereby. In any case, both polling software and interrupt handlers are well known in the art, and those skilled in the art will recognize that either method could be implemented without departing from the scope of the invention.

Thereafter at step 1214, DSP 224 assembles any raw data received from the J1708/RS-485 transceiver 216 and/or CAN transceiver 214 into messages, and at step 1216 DSP 224 determines whether any such messages are bound for transmission to a remote system or unit 225 via a USB communications link. If not, such messages are discarded at step 1218. In embodiments of system 200′ that include both the USB controller/transceiver 202′ and a RS-232 transceiver 218, an additional decision step may be interposed between steps 1216 and 1218 wherein DSP 224 makes a determination of whether any of the messages not bound for USB transmission are instead bound for transmission to a remote system or unit 225 via an RS-232 communications link. If not, the process may then proceed to step 1218 where any such messages are discarded. If, however, any such messages are bound for RS-232 transmission to a remote system or unit 225, the process may advance to an RS-232 data transmission process, one illustrative embodiment of which was described hereinabove with respect to FIG. 15.

Following step 1216, the process advances to step 1220 where DSP 224 reformats the assembled messages into frames of data configured for communication according to the USB communications protocol, and thereafter at step 1222 DSP 224 sends the assembled messages via its ADBUS I/O port to the USB controller/transceiver 202′ in the manner described hereinabove. Thereafter at step 1224, the USB controller/transceiver 202′ determines whether the frames are configured as USB host data frames or USB device data frames. If USB host frames, the process advances from step 1224 to step 1226 where the USB controller 202′, in cooperation with DSP 224, configures its USB communication port as a device port. Alternatively, the USB controller 202′, in cooperation with DSP 224, may at step 1226 configure its USB communication port as an on-the-go (OTG) port having USB device capabilities as described hereinabove. If, at step 1224 the USB data frames are determined by the USB controller/transceiver 202′ to be USB device data frames, the process advances from step 1224 to step 1228 where the USB controller 202′, in cooperation with DSP 224, configures its USB communication port as a host port. Alternatively, the USB controller 202′, in cooperation with DSP 224, may at step 1228 configure its USB communication port as an on-the-go (OTG) port having limited USB host capabilities as described hereinabove.

In any case, the process advances from either of steps 1226 or 1228 to step 1230 where the USB controller/transceiver 202′ transmits the data frames, reformatted according to the USB communications protocol, to a USB communications interface of the remote system or unit 225 coupled to the USB controller/ transceiver 202′ via an appropriate one of the communication paths 215₁-215_{M}. Following step 1230, the process ends at step 1232, and returns to the “start” step 1202.

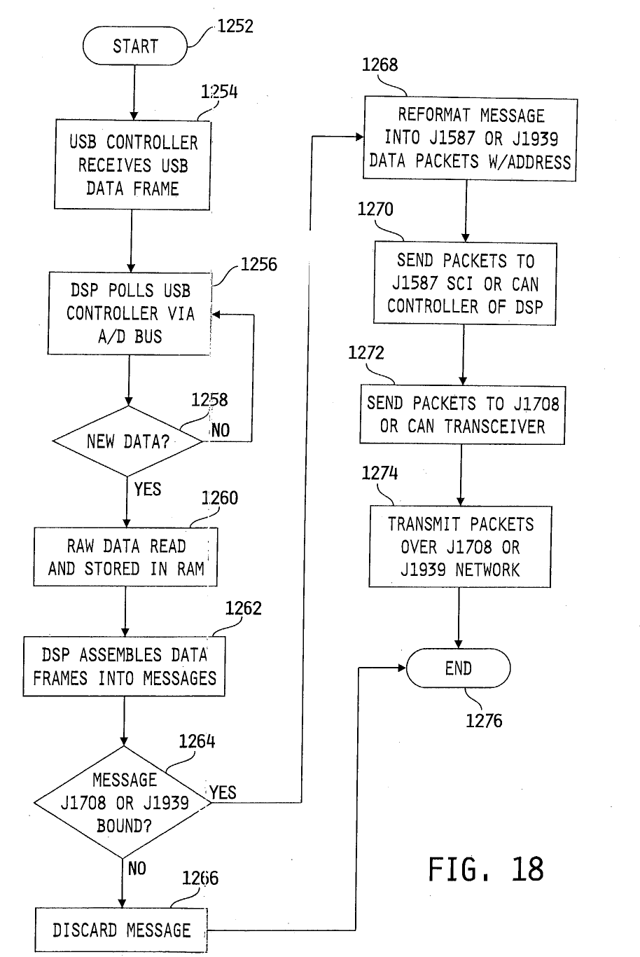

Referring now to FIG. 18, a flowchart is shown illustrating one embodiment of a process or algorithm for transferring information from the remote system or unit 225, configured for communication according to the USB communications protocol, to either of the J1708 or J1939 vehicle communications networks via the communications bridge system 200′ of FIGS. 11-14. The process begins at step 1252, and at step 1254, serial information in the form of data frames, transmitted by the remote system or unit 225 and configured according to the USB communications protocol, is received by the USB controller/transceiver 202′ coupled to the remote system or unit 225 via an appropriate one of the communication paths 215₁-215_{M}. Thereafter at steps 1256-1258, the DSP 224 polls the USB controller/transceiver 202′ for new data in a continuous polling cycle. During each cycle, any new raw data is read and stored in a data memory at step 1260, which may be either associated with DSP 224, auxiliary memory unit 244 or other external memory. Alternatively, DSP 224 may wait and respond as just described at step 1260 to an interrupt generated by the USB controller/transceiver 202′ when data is received thereby. In any case, both polling software and interrupt handlers are well known in the art, and those skilled in the art will recognize that either method could be implemented without departing from the scope of the invention.

Thereafter at step 1262, DSP 224 assembles any data frames received from the USB controller/transceiver 202′ into messages, and at step 1264 DSP 224 determines whether any of the messages are bound for transmission to either the J1708 vehicle communications network or the J1939 vehicle communications network. Any messages bound for neither vehicle communications network are discarded at step 1266. For any message bound for either the J1708 or J1939 vehicle communications network, DSP 224 is operable following step 1264 to reformat any such messages into appropriate data packets with addresses at step 1268. Messages bound for the J1708 vehicle communication network are reformatted by DSP 224 according to the SAE J1587 communications protocol, and any messages bound for the J1939 vehicle communications network are reformatted by DSP 224 according to the SAE J1939 communications protocol.

Following step 1268, the process advances to step 1270 where DSP 224 sends the reformatted data packets to an appropriate interface port. Those packets bound for the J1708 vehicle communications network are sent by DSP 224 to its J1587 SCI, and those packets bound for the J1939 vehicle communications network are sent by DSP 224 to its CAN controller. Thereafter at step 1272, DSP 224 sends the reformatted data packets to an appropriate transceiver for transmission to a corresponding one of the vehicle communication networks. Those packets bound for the J1708 vehicle communications network are sent by DSP 224 to the J1708/RS-485 transceiver 216, and those packets bound for the J1939 vehicle communications network are sent by DSP 224 to the CAN transceiver 214. Thereafter at step 1274, the transceivers 216 and/or 214 are operable to transmit the data provided to them by DSP 224 to one or more of the control computers carried by the vehicle 100 and coupled to either or both of the vehicle communications networks. For example, the J1708/RS-485 transceiver 216 is coupled to the J1708 vehicle communications link 108₁ via communications link 120₁, and the J1708/RS-485 transceiver 216 is operable at step 1274 to transmit the data supplied thereto by DSP 224, which data is configured for communications according to the SAE J1587 communications protocol, to any one or more in-vehicle control computers coupled to the J1708 vehicle communications network 108₁. Likewise, the CAN transceiver 214 is coupled to the J1939 vehicle communications link 108_{N} via communications link 120_{N}, and the CAN transceiver 214 is operable at step 1274 to transmit the data supplied thereto by DSP 224, which data is configured for communications according to the SAE J1939 communications protocol, to any one or more in-vehicle control computers coupled to the J1939 vehicle communications network 108_{N}. The process advances from step 1274 or from step 1266 to step 1276 where the process ends, and then returns to the “start” step 1252.

The illustrative embodiments described herein are exemplary, and are not intended to limit the claimed invention in any way. Although certain applications are described as specifically well suited for use with the current invention, it is believed to be useful in other applications as well. In fact, there are few, if any, internal combustion engine applications in which the present invention would not offer some benefit. Engine and engine controller manufacturers may choose to include the present invention in all engines, irrespective of the application.

What is claimed is:

1. A communications bridge between a communications network carried by a motor vehicle and configured for communications according to a first protocol and a remote system configured for communications according to a second protocol, the communications bridge comprising:
a first interface configured for coupling to said communications network;
a second interface configured for coupling to said remote system; and
a digital signal processor (DSP) configured to process multiple operations per instruction cycle, said DSP receiving information configured according to said first protocol from said communications network via said first interface, converting said information received from said communications network and configured according to said first protocol to said second protocol and transmitting said information converted to said second protocol to said remote system via said second interface, said DSP receiving information configured according to said second protocol from said remote system via said second interface, converting said information received from said remote system and configured according to said second protocol to said first protocol and transmitting said information converted to said first protocol to said communications network via said first interface.

2. The communications bridge of claim 1 further including a control computer carried by said motor vehicle and connected in communication with said communications network, said control computer providing said information configured according to said first protocol to said communications network.

3. The communications bridge of claim 1 wherein said communications network carried by said motor vehicle is a Society of Automotive Engineers (SAE) J1708 hardware network;
and wherein said first protocol is an SAE J1587 communications protocol configured for communication over said SAE J1708 hardware network.

4. The communications bridge of claim 3 wherein said first interface is a first transceiver configured for coupling to said SAE J1708 hardware network, said first transceiver operable to transmit and receive said information configured according to said SAE J1587 communications protocol to and from said SAE J1708 hardware network.

5. The communications bridge of claim 4 further including a control computer carried by said motor vehicle and connected in communication with said SAE J1708 hardware network, said control computer providing said information configured according to said SAE J1587 protocol to said SAE J1708 hardware network.

6. The communications bridge of claim 5 wherein said second protocol is an RS-232 communications protocol.

7. The communications bridge of claim 6 wherein said second interface is a second transceiver configured for coupling to an RS-232 communications port of said remote system, said second transceiver operable to transmit and receive said information configured according to said RS-232 communications protocol to and from said remote system.

8. The communications bridge of claim 7 wherein said remote system is a personal computer.

9. The communications bridge of claim 7 wherein said remote system is a hand-held personal digital assistant device.

10. The communications bridge of claim 5 wherein said second protocol is a universal serial bus (USB) communications protocol.

11. The communications bridge of claim 10 wherein said second interface is a USB controller having a first USB interface port configured for coupling to a second USB interface port of said remote system, said USB controller operable to transmit and receive said information configured according to said USB communications protocol to and from said remote system.

12. The communications bridge of claim 11 wherein said remote system is a personal computer.

13. The communications bridge of claim 11 wherein said remote system is a hand-held personal digital assistant device.

14. The communications bridge of claim 11 wherein said remote system is configured as a USB device;
and wherein said first USB interface port is configured as a USB host port.

15. The communications bridge of claim 11 wherein said first USB interface port is configured as an on-the-go USB port operable as a host USB port.

16. The communications bridge of claim 11 wherein said remote system is configured as a USB host;
and wherein said first USB interface port is configured as a USB device port.

17. The communications bridge of claim 11 wherein said first USB interface port is configured as an on-the-go USB port operable as a device USB port.

18. The communications bridge of claim 1 wherein said communications network carried by said motor vehicle is a Society of Automotive Engineers (SAE) J1939 hardware network;
and wherein said first protocol is an SAE J1939 communications protocol configured for communication over said SAE J1939 hardware network.

19. The communications bridge of claim 18 wherein said first interface is a first transceiver configured for coupling to said SAE J1939 hardware network, said first transceiver operable to transmit and receive said information configured according to said SAE J1939 communications protocol to and from said SAE J1939 hardware network.

20. The communications bridge of claim 19 further including a control computer carried by said motor vehicle and connected in communication with said SAE J1939 hardware network, said control computer providing said information configured according to said SAE J1939 protocol to said SAE J1939 hardware network.

21. The communications bridge of claim 20 wherein said second protocol is an RS-232 communications protocol.

22. The communications bridge of claim 21 wherein said second interface is a second transceiver configured for coupling to an RS-232 communications port of said remote system, said second transceiver operable to transmit and receive said information configured according to said RS-232 communications protocol to and from said remote system.

23. The communications bridge of claim 22 wherein said remote system is a personal computer.

24. The communications bridge of claim 22 wherein said remote system is a hand-held personal digital assistant device.

25. The communications bridge of claim 20 wherein said second protocol is a universal serial bus (USB) communications protocol.

26. The communications bridge of claim 25 wherein said second interface is a USB controller having a first USB interface port configured for coupling to a second USB interface port of said remote system, said USB controller operable to transmit and receive said information configured according to said USB communications protocol to and from said remote system.

27. The communications bridge of claim 26 wherein said remote system is a personal computer.

28. The communications bridge of claim 26 wherein said remote system is a hand-held personal digital assistant device.

29. The communications bridge of claim 26 wherein said remote system is configured as a USB device;
and wherein said first USB interface port is configured as a USB host port.

30. The communications bridge of claim 26 wherein said first USB interface port is configured as an on-the-go USB port operable as a host USB port.

31. The communications bridge of claim 26 wherein said remote system is configured as a USB host;
and wherein said first USB interface port is configured as a USB device port.

32. The communications bridge of claim 26 wherein said first USB interface port is configured as an on-the-go USB port operable as a device USB port.

33. A communications bridge between a communications network carried by a motor vehicle and configured for communications according to a first protocol and a remote system configured for communications according to a second protocol, the communications bridge comprising:
a first transceiver configured for coupling to said communications network;
a second transceiver configured for coupling to said remote system; and
a digital signal processor (DSP) configured to process multiple operations per instruction cycle, said DSP including a first communications port connected to said first transceiver and a second communications port connected to said second transceiver, said DSP configured to transmit and receive information configured according to said first protocol to and from said first transceiver via said first communications port and to transmit and receive information configured according to said second protocol to and from said second transceiver via said second communications port, said DSP providing for communications between said communications network and said remote system by converting said information between said first and second protocols.

34. The communications bridge of claim 33 further including a power supply configured to provide a first supply voltage to said first transceiver.

35. The communications bridge of claim 34 further including a power source selection circuit receiving one or more source voltages and selectively supplying one of said one or more source voltages as an input voltage to said power supply, said power supply producing said first supply voltage as a function of said input voltage.

36. The communications bridge of claim 35 wherein said power supply is further configured to provide a second supply voltage, as a function of said input voltage, to said DSP and to said second transceiver, said second supply voltage less than said first supply voltage.

37. The communications bridge of claim 35 wherein said DSP includes programmable flash memory;
and wherein said power supply is further configured to provide a flash memory programming voltage, as a function of said input voltage, to said DSP.

38. The communications bridge of claim 35 wherein said one or more source voltages includes a DC voltage supplied to said communications bridge via an external voltage source.

39. The communications bridge of claim 35 further including at least one battery supplying a battery voltage;
and wherein said one or more source voltages includes said battery voltage supplied by said battery.

40. The communications bridge of claim 35 wherein said second transceiver is a universal serial bus (USB) controller and transceiver circuit having a first USB port configured for coupling to a second USB port of said remote system, said first USB port including a voltage bus (VBUS) input configured to receive a DC voltage supplied by said remote system at a corresponding VBUS output of said second USB port;
and wherein said one or more source voltages includes said DC voltage received at said VBUS input of said first USB port.

41. The communications bridge of claim 34 wherein said DSP includes a voltage measuring input monitoring said DC voltage received at said VBUS input of said first USB port, said DSP measuring said DC voltage received at said VBUS input of said first USB port and providing a resulting measured voltage value to said remote system via a diagnostic message transmitted by said USB controller and transceiver circuit.

42. The communications bridge of claim 34 further including an external battery charging circuit receiving a charging voltage produced by said power supply and providing said charging voltage externally to said communications bridge.

43. The communications bridge of claim 42 wherein said remote system is a personal digital assistant (PDA) device;
and wherein said charging voltage produced by said external battery charging circuit is supplied to said PDA to charge one or more batteries carried thereby.

44. The communications bridge of claim 43 wherein said DSP includes a voltage measuring input monitoring said charging voltage produced by said power supply, said DSP measuring said charging voltage and providing a resulting measured voltage value to said PDA via a diagnostic message transmitted by said second transceiver.

45. The communications bridge of claim 38 wherein said DSP includes a voltage measuring input monitoring said DC voltage supplied by said external voltage source.

46. The communications bridge of claim 45 further including:
a power supply status indicator; and
a driver circuit having a control input connected to a control output of said DSP and a driver output connected to said power supply status indicator;
wherein said DSP is operable to control said power supply status indicator via said driver circuit to provide a visual indication of the measured value of said DC voltage.

47. The communications bridge of claim 46 wherein said power supply status indicator is a power supply status light emitting diode (LED), said DSP controlling said power supply status LED via said driver circuit such that said power supply status LED is illuminated whenever the measured value of said DC voltage is within a predefined voltage range, and is switched to an off state whenever the measured value of said DC voltage is below a threshold voltage value less than said predefined voltage range.

48. The communications bridge of claim 47 wherein said DSP is further operable to control said power supply status LED via said driver circuit such that said power supply status LED switches on and off at a predefined switching rate whenever the measured value of said DC voltage is outside said predefined voltage range.

49. The communications bridge of claim 33 further including:
a status indicator; and
a driver circuit having a control input connected to a control output of said DSP and a driver output connected to said status indicator;
wherein said DSP is operable to control said status indicator via said driver circuit to provide a visual indication of the status of information transfer between said communications network and said remote system.

50. The communications bridge of claim 49 wherein said communications network carried by said motor vehicle is a Society of Automotive Engineers (SAE) J1708 hardware network and said first protocol is an SAE J1587 communications protocol configured for communication over said SAE J1708 hardware network;
and wherein said first transceiver is operable to transmit and receive said information configured according to said SAE J1587 communications protocol to and from said SAE J1708 hardware network.

51. The communications bridge of claim 50 wherein said status indicator is a J1587/J1708 communications status light emitting diode (LED), said DSP switching said J1587/J1708 communications status LED on and off at a first predefined switching rate if said J1708 hardware network is non-responsive and said DSP is transmitting data via said first transceiver, switching said J1587/J1708 communications status LED on and off at a second predefined switching rate faster than said first switching rate if said J1708 hardware network is responsive and said DSP is transmitting information to and receiving information from said J1708 hardware network via said first transceiver, and maintaining said J1587/J1708 communications status LED in an off state whenever said DSP is neither transmitting information to nor receiving information from said J1708 hardware network via said first transceiver.

52. The communications bridge of claim 49 wherein said communications network carried by said motor vehicle is a Society of Automotive Engineers (SAE) J1939 hardware network and said first protocol is an SAE J1939 communications protocol configured for communication over said SAE J1939 hardware network;
and wherein said first transceiver is a controller area network (CAN) transceiver operable to transmit and receive said information configured according to said SAE J1939 communications protocol to and from said SAE J1939 hardware network.

53. The communications bridge of claim 52 wherein said status indicator is a J1939 communications status light emitting diode (LED), said DSP switching said J1939 communications status LED on and off at a first predefined switching rate if said J1939 hardware network is non-responsive and said DSP is transmitting data via said first transceiver, switching said J1939 communications status LED on and off at a second predefined switching rate faster than said first switching rate if said J1939 hardware network is responsive and said DSP is transmitting information to and receiving information from said J1939 hardware network via said CAN transceiver, and maintaining said J1939 communications status LED in an off state whenever said DSP is neither transmitting information to nor receiving information from said J1939 hardware network via said CAN transceiver.

54. The communications bridge of claim 49 wherein said second protocol is an RS-232 communications protocol;
and wherein said second transceiver is configured for coupling to an RS-232 communications port of said remote system, said second transceiver operable to transmit and receive said information configured according to said RS-232 communications protocol to and from said remote system.

55. The communications bridge of claim 54 wherein said status indicator is an RS-232 communications status light emitting diode (LED), said DSP switching said RS-232 communications status LED on and off at a first predefined switching rate if said second RS-232 communications port of said remote system is non-responsive and said DSP is transmitting data via said second transceiver, switching said RS-232 communications status LED on and off at a second predefined switching rate faster than said first switching rate if said second RS-232 communications port is responsive and said DSP is transmitting information to and receiving information from said remote system via said second transceiver, and maintaining said RS-232 communications status LED in an off state whenever said DSP is neither transmitting information to nor receiving information from said remote system via said second transceiver.

56. The communications bridge of claim 54 wherein said remote system is a personal computer.

57. The communications bridge of claim 54 wherein said remote system is a hand-held personal digital assistant device.

58. The communications bridge of claim 49 wherein said second protocol is a universal serial bus (USB) communications protocol;
and wherein said second transceiver is a USB controller and transceiver circuit having a first USB port configured for coupling to a second USB port of said remote system, said USB controller and transceiver circuit operable to transmit and receive said information configured according to said USB communications protocol to and from said remote system.

59. The communications bridge of claim 58 wherein said status indicator is a USB communications status light emitting diode (LED), said DSP switching said USB communications status LED on and off at a first predefined switching rate if said second USB port of said remote system is non-responsive and said DSP is transmitting data via said USB controller and transceiver circuit, switching said USB communications status LED on and off at a second predefined switching rate faster than said first switching rate if said second USB port of said remote system is responsive and said DSP is transmitting information to and receiving information from said remote system via said USB controller and transceiver circuit, and maintaining said USB communications status LED in an off state whenever said DSP is neither transmitting information to nor receiving information from said remote system via said USB controller and transceiver circuit.

60. The communications bridge of claim 58 wherein said remote system is a personal computer.

61. The communications bridge of claim 58 wherein said remote system is a hand-held personal digital assistant device.

62. A method of communicating information between at least one communications network carried by a motor vehicle and a remote system, said at least one communication network configured for communications according to a first protocol and the remote system configured for communications according to a third protocol, the method comprising the steps of:
receiving via a first interface coupled to said at least one communications network a first set of data from said at least one communications network configured according to said first protocol;
providing said first set of data received via said first interface to a digital signal processor (DSP) configured to process multiple operations per instruction cycle;
converting with said DSP said first set of data from said first protocol to said second protocol;
providing said first set of data configured according to said second protocol from said DSP to a second interface coupled to said remote system; and
transmitting to said remote system via said second interface said first data set configured according to said second protocol.

63. The method of claim 62 further including the steps of:
receiving from said remote system via said second interface a second set of data configured according to said second protocol;
providing said second set of data received via said second interface to said digital signal processor (DSP);
converting with said DSP said second set of data from said second protocol to said first protocol in accordance with a number of single-clock cycle DSP instructions;
providing said second set of data configured according to said first protocol from said DSP to said first interface; and
transmitting to said at least one communications network via said first interface said second data set configured according to said first protocol.

64. The method of claim 63 wherein the vehicle carrying the at least one communications network includes another communications network configured for communications according to a third protocol, the method further including the steps of:
receiving via a third interface coupled to said another communications network a third set of data from said another communications network configured according to said third protocol;
providing said third set of data received via said third interface to said digital signal processor (DSP);
converting with said DSP said third set of data from said third protocol to said second protocol in accordance with a number of single-clock cycle DSP instructions;
providing said third set of data configured according to said second protocol from said DSP to said second interface; and
transmitting to said remote system via said second interface said third data set configured according to said second protocol.

65. The method of claim 64 further including the steps of:
receiving from said remote system via said second interface a fourth set of data configured according to said second protocol;
providing said fourth set of data received via said second interface to said digital signal processor (DSP);
converting with said DSP said fourth set of data from said second protocol to said third protocol in accordance with a number of single-clock cycle DSP instructions;
providing said fourth set of data configured according to said third protocol from said DSP to said third interface; and
transmitting to said another communications network via said third interface said fourth data set configured according to said third protocol.

66. The method of claim 65 wherein said at least one communications network is a society of automotive engineers (SAE) J1708 hardware network and said first protocol is an SAE J1587 communications protocol configured for communication over said J1708 hardware network;
and wherein said another communications network is an SAE J1939 hardware network and said third protocol is an SAE J1939 communications protocol configured for communication over said J1939 hardware network.

67. The method of claim 66 wherein said second protocol is an RS-232 communications protocol.

68. The method of claim 66 wherein said second protocol is a universal serial bus (USB) communications protocol.
